(19) United States
(12) Patent Application Publication
(10) Pub. No.: US 2007/0048071 A1
(43) Pub. Date: Mar. 1, 2007

(54) Fastening system for a ring binder mechanism

(75) Inventors: Shan Jun Li, Chong Qing City (CN); Wing Yiu Ng, Hong Kong (CN); Ming Hah Wong, Hubei Provice (CN)

Correspondence Address: SENNIGER POWERS, ONE METROPOLITAN SQUARE, 16TH FLOOR, ST LOUIS, MO, 63102, US

(73) Assignee: World Wide Stationery Mfg. Co., Ltd., Hong Kong (CN)

(21) Appl. No.: 11/388,506

(22) Filed: Mar. 24, 2006

Related U.S. Application Data
(63) Continuation-in-part of application No. 11/216,907, filed on Aug. 31, 2005.

(51) Int. Cl. B42F 13/30

(52) U.S. Cl. 402/54

(57) ABSTRACT

A ring binder mechanism has an elongate housing and at least one ring for mounting loose leaf paper. The ring includes ring members supported by the housing for movement relative to each other between a closed position and an open position. At least one mounting structure extends outwardly from the housing and has first and second ends. The first end is adapted for attachment to the housing and the second end has an aperture therein. A retainer is affixed to the mounting structure. A fastener is adapted for connection with the retainer for securing the housing to a substrate.

### CROSS-REFERENCE TO RELATED APPLICATION

This application is a continuation-in-part of co-pending U.S. patent application Ser. No. 11/216,907 filed Aug. 31, 2005, which is incorporated herein by reference in its entirety.

### BACKGROUND OF THE INVENTION

This invention relates to ring binders for retaining loose-leaf pages, and in particular to a fastening system for attaching a ring binder mechanism to a cover to form the ring binder.

Conventional ring binders are made by securing a ring binder mechanism to a cover using rivets. Commonly, ring binder mechanisms include a housing and a plurality of ring members attached to the housing for retaining loose-leaf pages, such as hole-punched pages. Typically, the ring binder mechanism is secured to the cover by inserting the rivets through the cover and openings in the ring binder mechanism. The tail of each of the rivets is then deformed (e.g., by punching) to engage and fasten the ring binder mechanism. Once assembled, the ring binder is packaged and shipped to a distributor, a retailer, or directly to an end user (i.e., consumer).

One of the drawbacks of traditional ring binders relates to their shipping and storage after they are assembled. When assembled, large gaps exist between the ring binder mechanism and the cover for each ring binder leaving large amounts of room unused during shipping and storing of multiple ring binders. Thus, the number of ring binders in each package is greatly limited. As a result, packaging and shipping conventional ring binders is inefficient which results in significant shipping and handling costs. Moreover, even a limited number of ring binders occupy a substantial amount of storage space or retail display space.

In response to this drawback, manufacturers of ring binders typically pack the mechanisms in alternating directions. But even this packing technique leaves large amounts of unused space. Further efforts to overcome some of the short comings of conventional ring binders have been disclosed in coassigned U.S. Pat. No. 5,924,811 to To et al., U.S. Pat. No. 5,879,097 to Cheng, and U.S. Pat. No. 5,160,209 to Schuessler, all of which are hereby incorporated by reference in their entireties.

### SUMMARY OF THE INVENTION

In one aspect, a ring binder mechanism of the present invention generally comprises an elongate housing and at least one ring for mounting loose leaf paper. The ring includes first and second ring members. Each of the ring members is supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring. At least one mounting structure extends outwardly from the housing and has first and second ends. The first end is adapted for attachment to the housing and the second end has an aperture therein. A retainer is affixed to the mounting structure. A fastener is adapted for connection with the retainer for securing the housing to a substrate.

In another aspect, a ring binder mechanism of the present invention generally comprises an elongate housing having a top and at least one opening extending through the housing. At least one ring for mounting loose leaf paper includes first and second ring members. Each of the ring members is supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring. At least one fastener has a stem and a head. At least one retainer is associated with the housing for connection with the retainer for securing the housing to a substrate. The fastener is sized and shaped so that when the fastener is used to secure the housing to a substrate, a portion of the stem of the fastener extends above at least a portion of the top of the housing.

Other objects and features of the present invention will be in part apparent and in part pointed out hereinafter.

### BRIEF DESCRIPTION OF THE DRAWINGS

FIG. 1 is a fragmentary perspective of a ring binder including a cover and a ring binder mechanism attached to a spine of the cover, the ring binder mechanism being attached to the cover using a fastening system of the present invention;

FIG. 2 is a perspective similar to FIG. 1 with the ring binder mechanism exploded from the spine of the cover, the remainder of the cover not being shown;

FIG. 3A is a section taken on line 3A-3A of FIG. 2;

FIG. 3B is a section similar to FIG. 3A but showing the ring binder mechanism engaging the cover and a fastener being partially inserted through the spine and into the ring binder mechanism;

FIG. 3C is a section taken on line 3C-3C of FIG. 1 which shows the fastener fully inserted through the spine and into ring binder mechanism;

FIG. 4 is a bottom side perspective of the ring binder mechanism;

FIG. 4A is an enlarged perspective of circled portion of the ring binder mechanism of FIG. 4 showing a mounting post having a retainer affixed thereto;

FIG. 5 is an exploded perspective of the ring binder mechanism of FIG. 4;

FIG. 6 is the perspective of FIG. 4 but with ring members in an open position;

FIG. 7A is an enlarged fragmentary perspective of the ring binder mechanism with a housing removed showing a lever connected to hinge plates;

FIG. 7B is a section taken on line 7B-7B of FIG. 7A;

FIG. 8A is a perspective of the mounting post and the retainer exploded from the mounting post;

FIG. 8B is a perspective similar to FIG. 8A but showing the retainer affixed to the mounting post;

FIG. 9 is an exploded perspective of a cover spine, a ring binder mechanism and a fastening system having another configuration;

FIG. 10 is a view similar to FIG. 9 but showing the fastening system used to attach the ring binder to the spine partially assembled;

FIG. 11 is a view similar to FIG. 10 but showing the fastening system attaching the ring binder mechanism to the spine;

FIG. 12 is a section taken on line 12-12 of FIG. 11;

FIG. 13 is an exploded perspective of a spine cover, a ring binder mechanism and a fastening system of yet another configuration;

FIG. 14 is a view similar to FIG. 13 but showing the fastening system attaching the ring binder mechanism to the spine;

FIG. 15 is a section taken on line 15-15 of FIG. 14;

FIG. 16 is an enlarged fragment of the perspective of FIG. 14 with parts broken away and parts removed to show the fastening system;

FIG. 17 is a bottom side perspective of the ring binder mechanism having clips of the fastening system connected thereto;

FIG. 18A is a perspective of the clip showing a retainer removed therefrom;

FIG. 18B is a view similar to FIG. 18A but showing the retainer affixed to the clip;

FIG. 19 is an exploded perspective of a cover spine, a ring binder mechanism and a fastening system having a further configuration;

FIG. 20 is a view similar to FIG. 19 but showing the fastening system attaching the ring binder mechanism to the spine;

FIG. 21 is a section taken on line 21-21 of FIG. 20;

FIG. 22 is a perspective of a clip showing a retainer affixed to the clip;

FIG. 23 is an exploded perspective of a cover spine, a ring binder mechanism and a fastening system having still a further configuration;

FIG. 24 is a view similar to FIG. 23 but showing the fastening system attaching the ring binder mechanism to the spine;

FIG. 25 is an exploded perspective of a cover spine, a ring binder mechanism and a fastening system having still yet another configuration;

FIG. 26 is a view similar to FIG. 25 but showing the fastening system attaching the ring binder mechanism to the spine;

FIG. 27 is a fragmentary section taken on line 27-27 of FIG. 26;

FIG. 28 is an exploded perspective of a cover spine, ring binder mechanism and a fastening system having another configuration;

FIG. 29 is a view similar to FIG. 28 but showing the fastening system attaching the ring binder mechanism to the spine;

FIG. 30A is an enlarged fragmentary perspective showing the ring binder mechanism and a retainer exploded therefrom;

FIG. 30B is a perspective of the ring binder mechanism showing the retainers attached thereto;

FIG. 30C is a bottom side perspective showing the retainers attached to the ring binder mechanism;

FIG. 31 is an exploded perspective of a cover spine, ring binder mechanism and a fastening system having still yet another configuration;

FIG. 32 is a view similar to FIG. 31 but showing the fastening system used to attach the ring binder mechanism to the spine partially assembled;

FIG. 33A is a perspective showing a cap having a retainer in an unlocked position;

FIG. 33B is a perspective similar to FIG. 33A but showing the retainer in a locked position;

FIG. 33C is a fragmentary perspective showing the cap partially cut away to show the retainer in the locked position;

FIG. 34 is an exploded perspective showing a cover spine, a ring binder mechanism and a fastening system having a further configuration;

FIG. 35 is a view similar to FIG. 34 but showing the fastening system used to attach the ring binder to the spine partially assembled;

FIG. 36 is a view similar to FIG. 35 but showing the fastening system attaching the ring binder mechanism to the spine;

FIG. 37 is a section taken on line 37-37 of FIG. 36;

FIG. 38A is a perspective showing a cap having a retainer removed therefrom;

FIG. 38B is a perspective similar to FIG. 38A but showing the retainer affixed to the cap;

FIG. 39 is an exploded perspective of a cover spine, a ring binder mechanism and a fastening system having still another configuration;

FIG. 40 is a view similar to FIG. 39 but showing the fastening system used to attach the ring binder to the spine partially assembled;

FIG. 41 is a view similar to FIG. 40 but showing the fastening system attaching the ring binder mechanism to the spine;

FIG. 42A is a perspective of a mounting post having a retainer removed therefrom; and

FIG. 42B is a perspective similar to FIG. 42A but showing the retaining affixed to the mounting post.

Corresponding reference characters indicate corresponding parts throughout the several views of the drawings.

### DETAILED DESCRIPTION OF THE INVENTION

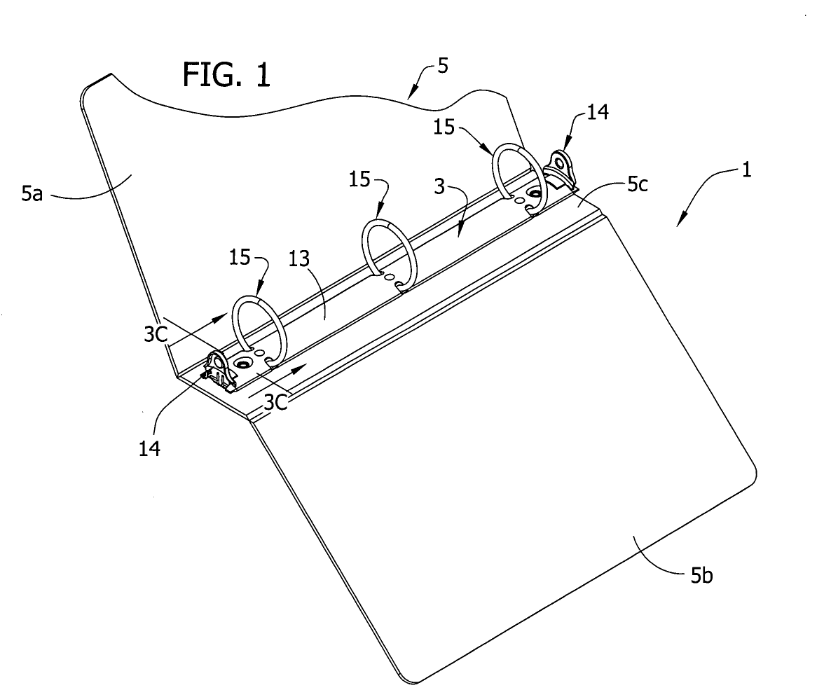

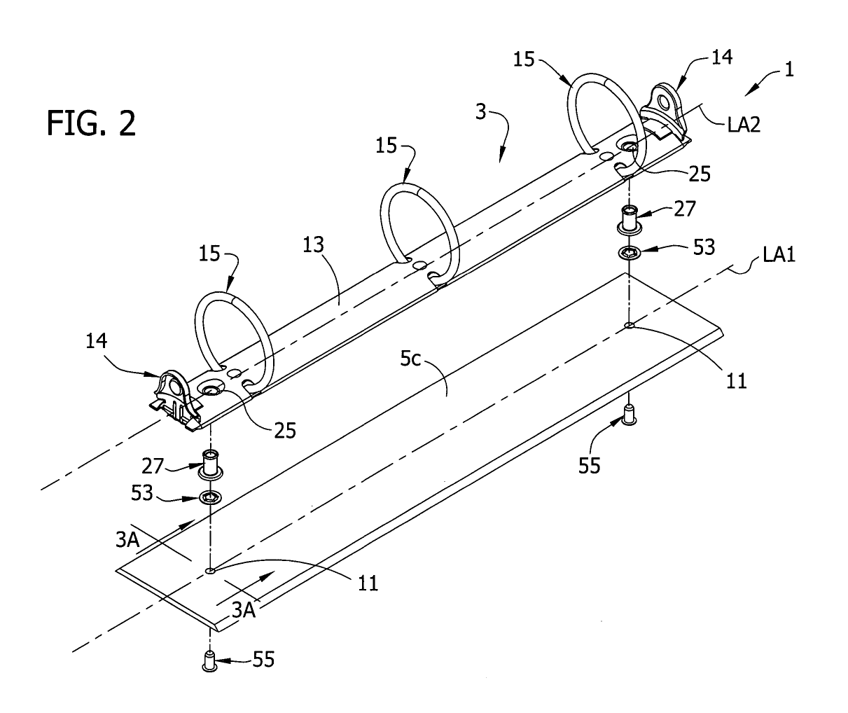

Referring now to the drawings, and particularly to FIGS. 1 and 2, a ring binder according to the present invention is designated generally by reference numeral 1. The ring binder 1 comprises a ring binder mechanism 3 affixed to a cover 5 (broadly, “a substrate”). The cover and ring binder mechanism are indicated generally by their respective reference numbers. The cover 5 includes a front panel 5a, a back panel 5b, and a spine 5c. A portion of the front panel 5a is partially broken away but the front panel is substantially the same as the back panel 5c. The front and back panels 5a, 5b are hingedly attached to the spine 5c so that they can be moved to selectively cover or expose loose leaf pages (not shown) retained by the ring binder mechanism 3. While the ring binder mechanism 3 is shown in FIG. 1 as being affixed to the spine 5c of the cover 5, it is understood that the ring binder mechanism can be affixed to the front or back panels 5a, 5b of the cover. Moreover, the ring binder mechanism 3 can be mounted on substrates other than the cover 5, such as files, without departing from the scope of the present invention.

The spine 5c of the cover includes, as shown in FIG. 2, two circular apertures 11 therein for use in mounting the ring binder mechanism 3 to the cover 5 as described in more detail below. The apertures 11 are axially aligned along a longitudinal axis LA1 of the spine 5c so that when the ring binder mechanism 3 is attached to the spine, a longitudinal axis LA2 of the ring binder mechanism is generally parallel to the longitudinal axis of the spine (FIG. 1). The number of apertures 11 may be other than two and the shape of the apertures may be other than circular within the scope of the present invention.

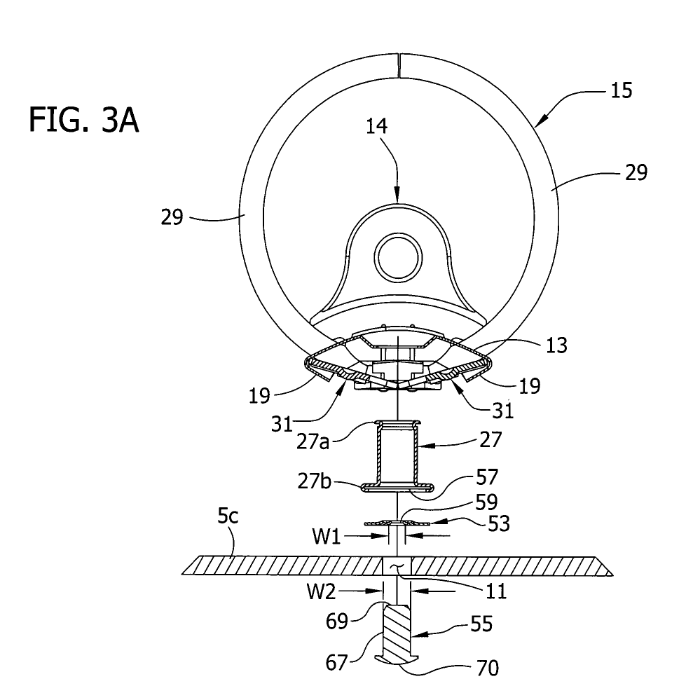

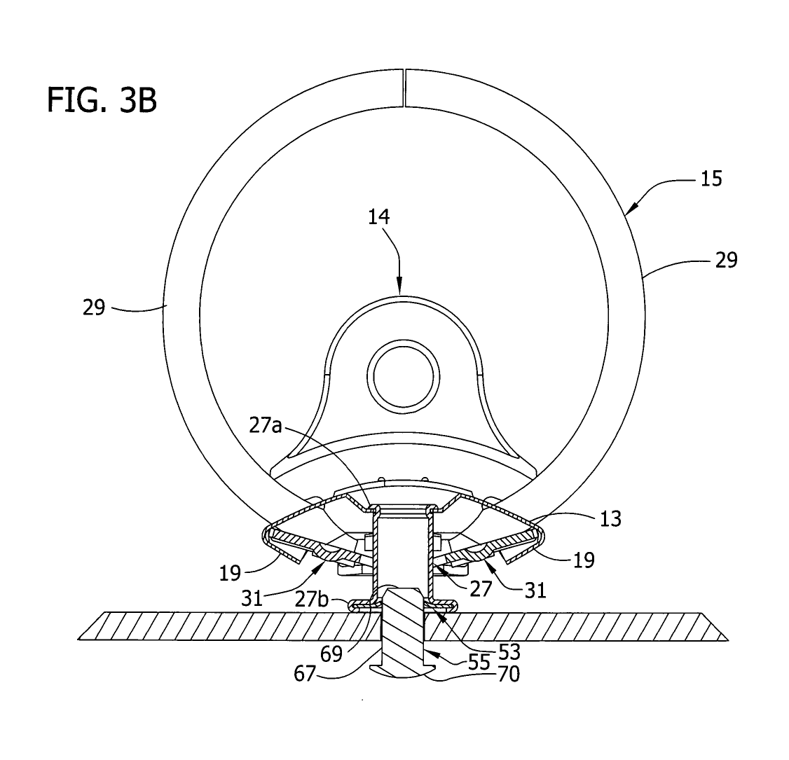

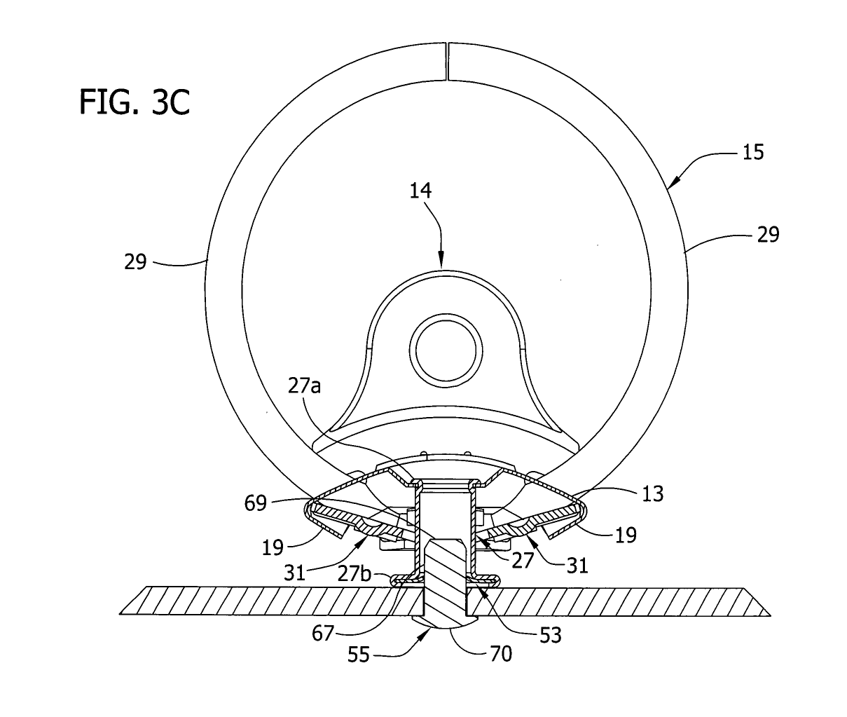

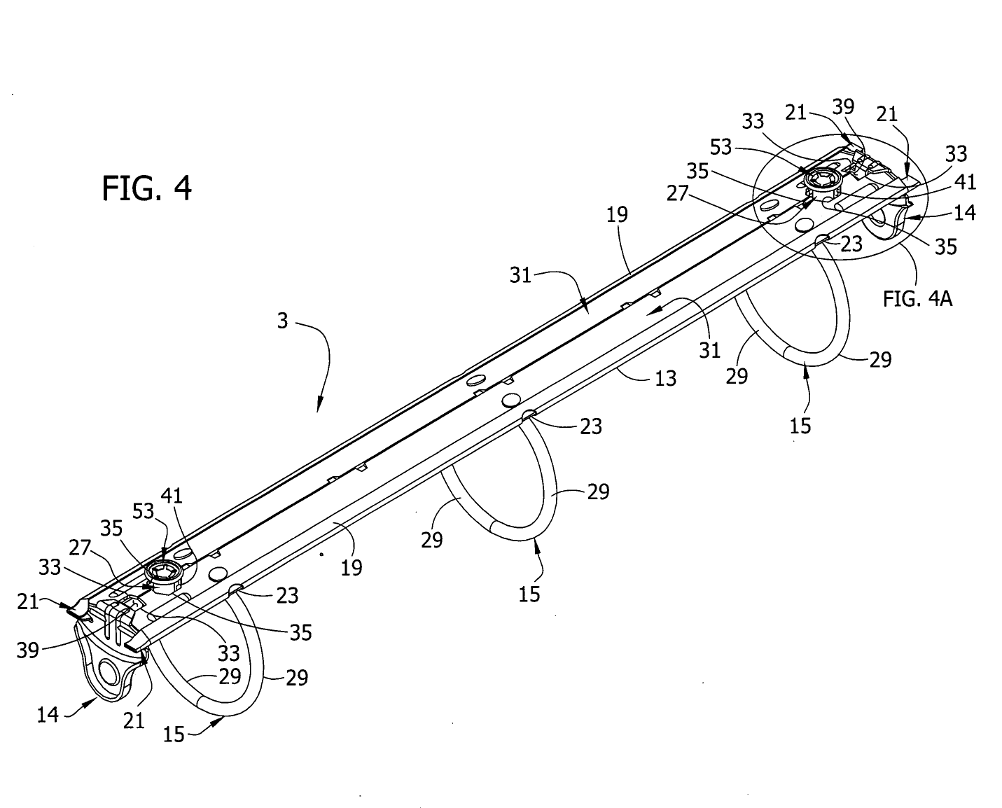

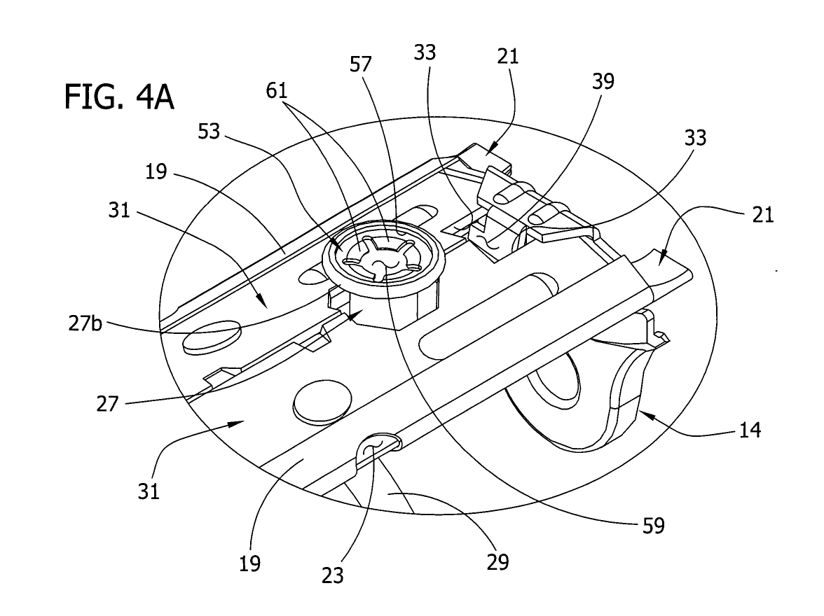

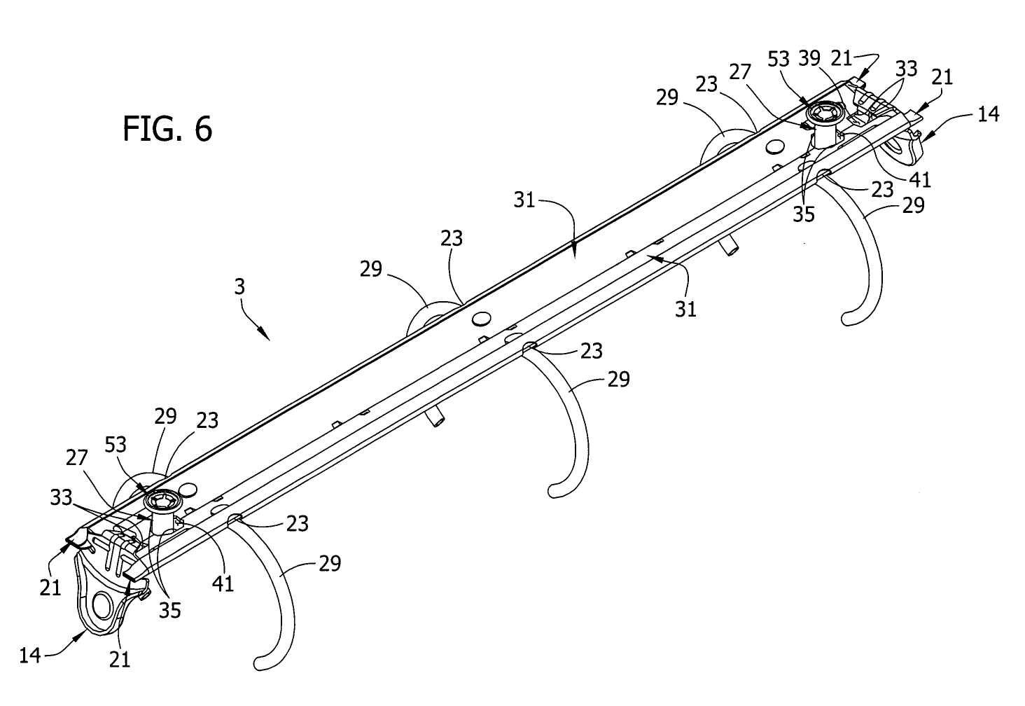

As shown in FIGS. 1 and 2, the ring binder mechanism 3 includes an elongate housing 13 that supports two substantially similar actuating levers (each designated generally by reference numeral 14) and three rings (each designated generally by reference numeral 15). The housing 13 is symmetrical with a roughly arch-shaped cross section (see FIGS. 3A-3C) and includes two transversely opposite longitudinally extending edges, and two longitudinal ends (see FIG. 2). Each lever 14 pivotally mounts on the housing 13, generally at an opposite longitudinal end, for controlling movement of the rings 15 between a closed position (see FIG. 4) and an open position (see FIG. 6). The use of the levers 14 for moving the rings 15 is described in detail below.

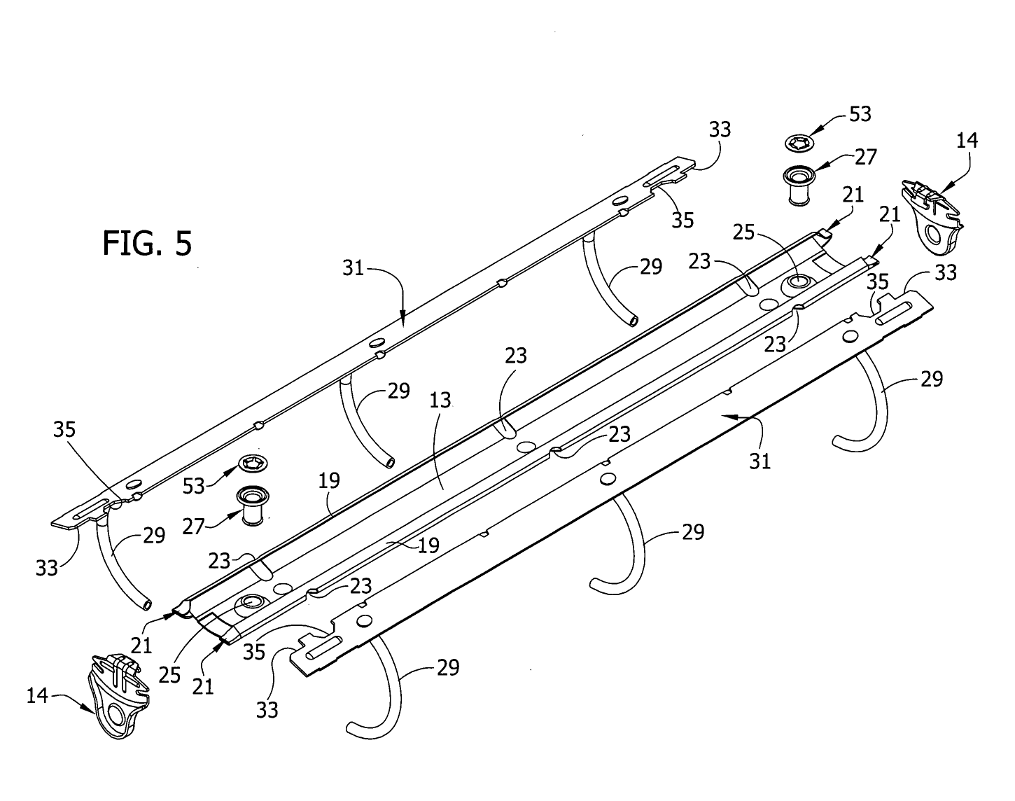

As shown in FIGS. 4-6, a bent under rim 19 is formed along each longitudinal edge of the housing 13 and extends the full length of the housing from one longitudinal end to the other. Each end of the two bent under rims 19 is pinched together with a portion of an upper surface of the housing 13 to form four pockets (each pocket being designated by reference numeral 21). Accordingly, there are two pockets 21 adjacent each longitudinal end of the housing 13. Six slots 23 are positioned along the two bent under rims 19. The slots 23 are arranged in three transversely opposed pairs with each pair receiving one of the rings 15 therethrough, allowing each ring to move laterally of the housing 13 for opening and closing. As shown in FIGS. 2 and 5, two circular openings 25 are located in the housing 13, near the longitudinal ends, each being adapted to receive and attach a mounting post (broadly, “mounting structure”), generally indicated at 27, to the housing 13 for supporting the ring binder mechanism 3 above the spine 5c of the cover 5. It is envisioned that the housing of the present invention is made of metal, but it may be made of any other suitable material that is sufficiently rigid to provide a stable mount for components of the mechanism. In addition, differently shaped housings, including asymmetrical ones, do not depart from the scope of this invention.

Each of the rings 15 comprises two ring members 29, which are supported by the housing 13 for movement relative to one another between a closed position (see FIGS. 1 and 4) and an open position (see FIG. 6). In the closed position, the ring members 29 form a substantially continuous, closed, ring or loop for retaining loose-leaf pages and for allowing the pages to move along the rings 15 from one ring member 29 to the other. In the open position, each ring member 29 forms a discontinuous, open loop suitable for adding or removing pages. It is envisioned that the ring members are formed of a conventional, cylindrical rod of suitable material, such as steel. But it is understood that ring members having a different cross section or ring members made of different material do not depart from the scope of the present invention. Although in the illustrated mechanism both ring members can move, mechanisms having one movable ring member and one fixed do not depart from the scope of the invention. In addition, mechanisms with greater or fewer than three rings or with rings that form other shapes, such as slanted “D” shapes, when ring members are closed, do not depart from the scope of this invention.

As shown in FIG. 5, the two ring members 29 of each ring 15 are mounted opposite each other on one of a pair of hinge plates (each hinge plate being designated generally by reference numeral 31). The hinge plates are each thin and elongate, having an inner and an outer longitudinal edge margin and two longitudinal ends. Each hinge plate 31 additionally includes two squared notches 33 and two rounded cutouts 35, each of which are located along the inner longitudinal edge margin of the hinge plate. The two notches 33 are each located at a respective longitudinal end of the hinge plate 31, and the two cutouts 35 are each located inward from one of the respective notches 33 but still generally adjacent the hinge plate's ends.

Referring now to FIGS. 4, 4A, and 6, the hinge plates 31 attach to one another in parallel arrangement along their inner longitudinal edge margins, forming a central hinge having a pivot axis. The housing 13 loosely receives the outer longitudinal edge margins of the interconnected hinge plates 31 above its two bent under rims 19. Thus, the hinge plates 31 are retained on the housing 13 while the outer longitudinal edge margins are free to move within the rims 19. Corresponding notches 33 of the adjoining hinge plates align to form two box-shaped recesses 39 at opposite longitudinal ends of the plates 31. These recesses 39 are sized and shaped to interact with the actuating levers 14, as will be described in more detail hereinafter. Similarly, corresponding cutouts 35 align to form two roughly circular openings 41, each sized and shaped for receiving one of the mounting posts 27 through the hinge plates 31. In the illustrated mechanism, the box-shaped recesses 39 and the circular openings 41 are both symmetrically positioned about the pivot axis of the interconnected hinge plates 31. However, mechanisms in which openings and recesses are positioned differently about a pivot axis of interconnected hinge plates do not depart from the scope of the present invention.

The housing 13 is slightly narrower than the joined hinge plates 31 when the hinge plates are in a coplanar position (i.e., an angle between exterior surfaces of the hinge plates is 180°). So as the hinge plates 31 pivot through this position, they deform the resilient housing 13 and cause a spring force in the housing that urges the hinge plates 31 to pivot away from the coplanar position, either closing the ring members 29 (i.e., moving the pivot axis down and away from the housing's upper surface (FIG. 4)) or opening them (i.e., moving the pivot axis up and toward the housing's upper surface (FIG. 6)). Moreover, when the ring members 29 are closed, this spring force resists hinge plate movement and clamps the ring members together. When the ring members 29 are open, the spring force holds them apart. Thus, the illustrated embodiment uses a conventional arrangement to move the hinge plates 31 and ring members 29. It will be understood that other ways of moving the ring members 29 and locking them in a closed position or an open position may be used within the scope of the present invention.

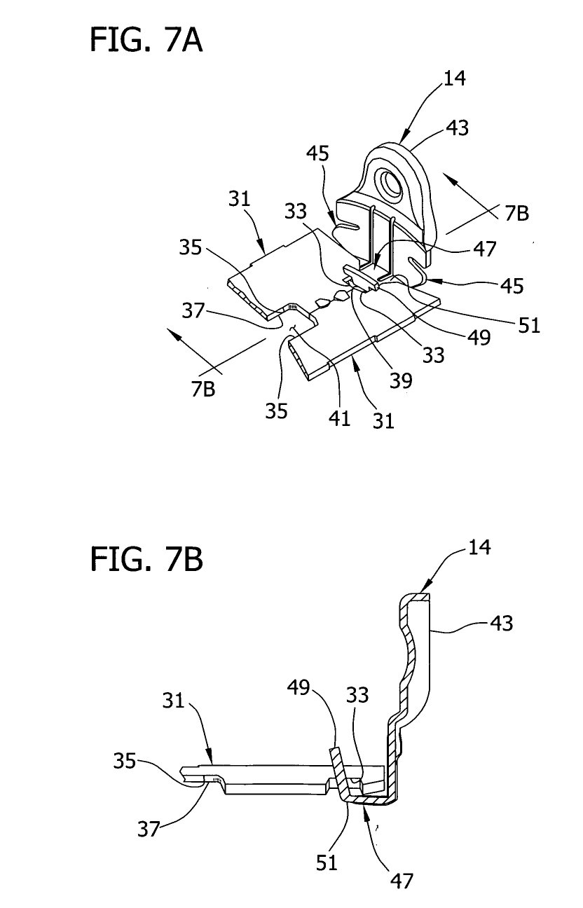

The two actuating levers 14 are shown best in FIGS. 4A, 7A, and 7B. Each lever 14 includes a relatively flat head 43 that extends upward, generally above the housing 13, for grasping to pivot the lever. Each additionally includes two lateral arms, each designated by reference numeral 45, and a cam, designated generally by reference numeral 47. As best shown in FIG. 7A, the lateral arms 45 extend laterally outward from opposite sides of each lever 14 below the flat head 43. The two arms 45 of each lever loosely fit within the two pockets 21 located at each longitudinal end of the housing 13, allowing the levers 14 to pivot within the pockets relative to the housing about an axis transverse to the housing (FIGS. 4 and 6). Referring again to FIGS. 7A and 7B, the cam 47 of each lever is integrally attached to the lever 14 below the lateral arms 45. It extends downward from the arms 45 and curves outward from the flat head 43, fitting into one of the respective box-shaped recesses 39 of the hinge plates 31. An enlarged tab 49 of each cam fits loosely over the interconnected hinge plates 31 while a base 51 of each cam rests below the plates. Together, the tab 49 and base 51 capture the hinge plates 31 therebetween for operable engagement to control the pivoting motion of the hinge plates that close and open the ring members 29. In operation to close the ring members 29, the levers 14 are pivoted upward and inward. The tabs 49 engage a top surface of the hinge plates 31 and pull the pivot axis of the plates downward. To open the ring members 29, the levers 14 are pivoted outward and downward. The bases 51 engage a bottom surface of the hinge plates 31 and push the pivot axis of the plates upward. Mechanisms (not shown) having levers with different shapes or levers pivotally attached to a housing differently do not depart from the scope of the present invention. In addition, mechanisms having only one lever for driving the hinge plates do not depart from the scope of the present invention. Moreover, mechanisms having no levers, for example, ones that are closed by manually pushing the rings together or opened by manually spreading the rings do not depart from this scope of this invention.

The two mounting posts 27, as shown in FIGS. 2 and 3C, are located adjacent the levers 14 and space the ring binder mechanism from the cover 5 so that the hinge plates 31 can pivot without engaging the spine 5c. In this position, the mounting posts 27 align with the respective oval openings 41 of the interconnected hinge plates 31 and pass through the hinge plates without interfering with their operation (FIG. 4A). Each mounting post 27 is tubular in shape and has two open ends. At a first end, each of the mounting posts 27 includes a deformable lip 27a that attaches the bushing to one of the circular openings 25 in the upper surface of the housing 3 (FIGS. 3B and 3C). It will be understood that other ways of attaching the mounting post 27 to the housing 3 may be used without departing from the scope of the present invention. At a second end, each of the mounting posts 27 includes a circular rim 27b defining an aperture 57 in the, second end (FIG. 3A). It is understood that more or fewer mounting posts 27 can be used without departing from the scope of this invention.

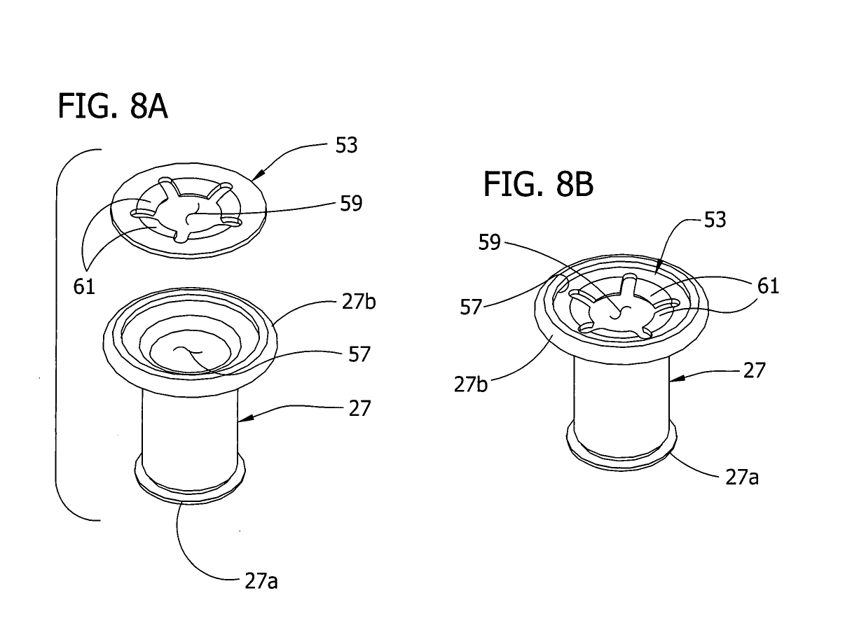

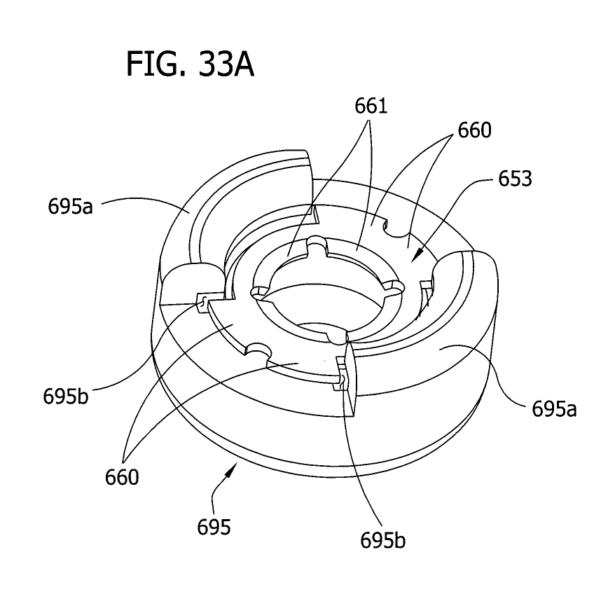

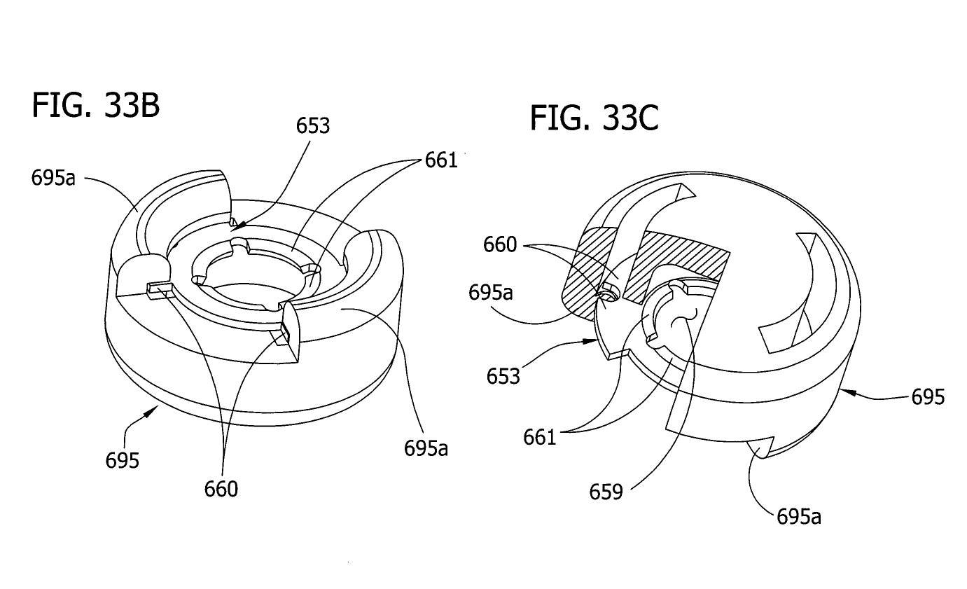

As shown in FIGS. 2-3C, the ring binder mechanism 3 is affixed to the cover 5 using a pair of retainers, generally indicated at 53, and a pair of fasteners, generally indicated at 55. Each of the retainers 53 are received in the aperture 57 of the mounting posts 27 and affixed to the circular rim 27b (FIGS. 8A and 8B) by a bent over outer edge of the circular rim 27b. Each of the retainers 53 is sized and shaped for receiving and retaining one of the fasteners 55 for attaching the ring binder mechanism 3 to the spine 5c of the cover 5. Accordingly, each retainer 53 has a central opening 59 and a plurality of tabs 61 extending generally around and projecting into the central opening. The tabs 61 are angled so that when the retainers 53 are affixed to the mounting posts 27, the tabs 61 extend inward toward the lip 27a of the mounting posts. Five tabs 61 are shown in the illustrated configuration but more or fewer tabs can be used. For example, a retainer shown in FIGS. 33A-33C has only four tabs.

As shown in FIG. 3A-3C, each of the fasteners 55 is passed through one of the apertures 11 in the spine 5c of the cover 5 and a respective openings 59 in one of the retainer 53 for securing the ring binder mechanism 3 to the cover 5. Each of the fasteners 55 includes a shaft 67 having a rounded free end 69 and a head 70 attached to other end of the shaft (i.e., the end opposite the free end). The free end 69 is tapered to make it easier to insert the shaft 67 of the fastener 55 through the aperture 11 in the spine 5c and the opening 59 in the retainer 53. The tabs 61 of the retainer 53 are resiliently deformable and the openings 59 in each of the retainers defined by the tabs 61 have a width W1 that less than a width W2 of the shaft 67 of the fastener 55 (FIG. 3A). As shown in FIG. 3B, when the fastener 55 is being pushed through the opening 59 in the retainer 53, the tabs 61 deform (i.e., deflect axially toward the lip 27a of the mounting post 27) thereby allowing the wider shaft 67 to pass through the opening. As the fastener 55 is being pushed through the opening 59 in the retainer 53, the free ends of the tabs 61 engage and slide along the surface of the shaft 67 of the fastener. Once inserted, the free ends of the tabs 61 remain in contact with the surface of the shaft 67 and inhibit removal of the fastener 55 from the retainer 53. The angle of the tabs 61 helps guide the fastener 55 through the opening 59, facilitates the deformation of the tabs, and also allows the free ends of the tabs to grip the surface of the shaft 67 of the fastener. The fasteners are inhibited from removal by the free ends of the tabs 61 gripping the surface of the shaft of the fasteners. Movement tending to withdraw the fastener 55 from the mounting post 27 and retainer 53 causes the tabs 61 to move toward a planar configuration of the retainer. This reduces the size of the opening 59 and causes the tabs 61 to bear harder against the fastener 55, thereby preventing its withdrawal. Each of the fastener heads 70 engage an outer surface of the spine 5c when the fasteners 55 are used to secure the ring binder mechanism 3 to the cover 5.

Ring binders 1 of the present invention can be easily and manually assembled. The ring binder mechanism 3 is positioned so that the longitudinal axis LA2 of the ring binder mechanism aligns with the longitudinal axis LA1 of the spine 5c of the cover 5, and the openings 59 in the retainers 53 supported by the mounting posts 27 are aligning with the apertures 11 in the spine of the cover. Next, each of the fasteners 55 is inserted through one of the apertures 11 in the cover 5, and the opening 59 in the respective retainer 53 so that the tabs 61 of the retainer grip the shaft 67 of the fastener to thereby secure the ring binder mechanism 3 to the cover.

Accordingly, ring binders 1 of the present invention can be packaged, shipped, stored and/or sold without having the ring binder mechanism 3 securely attached to the covers 5. For example, multiple covers 5 can be packaged and shipped together such that little space between adjacent covers is wasted. This can be done by lying the covers 5 flat such that the front panel 5a, back panel 5b, and spine 5c are all substantially in the same plane, and stacking others on top. The ring binder mechanisms 3 and fasteners 55 can be packaged in the same container as the covers 5 or separately. Either way, the ring binder mechanism 3 can also be arranged to minimize wasted space. One possible packing arrangement for the ring binder mechanisms 3 is to pack them in alternating directions such that the rings 15 of one mechanism are positioned between the rings of an adjacent mechanism. As a result, the separated covers 5 and ring binder mechanisms 3 can be packaged, shipped, and stored more efficiently and cost effectively than ring binders having the ring binder mechanisms attached.

The ring binder mechanisms 3 can be attached to the covers 5, for example, by the retailer before transferring them to a customer (i.e, after a sale) or before placing them on display. It is also understood that the customer may wish to maintain the ring binder mechanisms 3 and covers 5 separately to take advantage of the saved storage space. Thus, the customer may be the one who attaches the ring binder mechanism 3 to the cover 5. Accordingly, it is understood that the ring binder mechanism and cover of the present invention can be joined to form a ring binder at any of various times. The examples of the ring binder mechanism being attached to the cover by a retailer and a customer are exemplary only as it is understood that other individuals, including the ring binder manufacturer, may assemble the ring binder. It is also understood that the ring binder mechanism could be attached to the cover using an automated process as well as the manual process described herein.

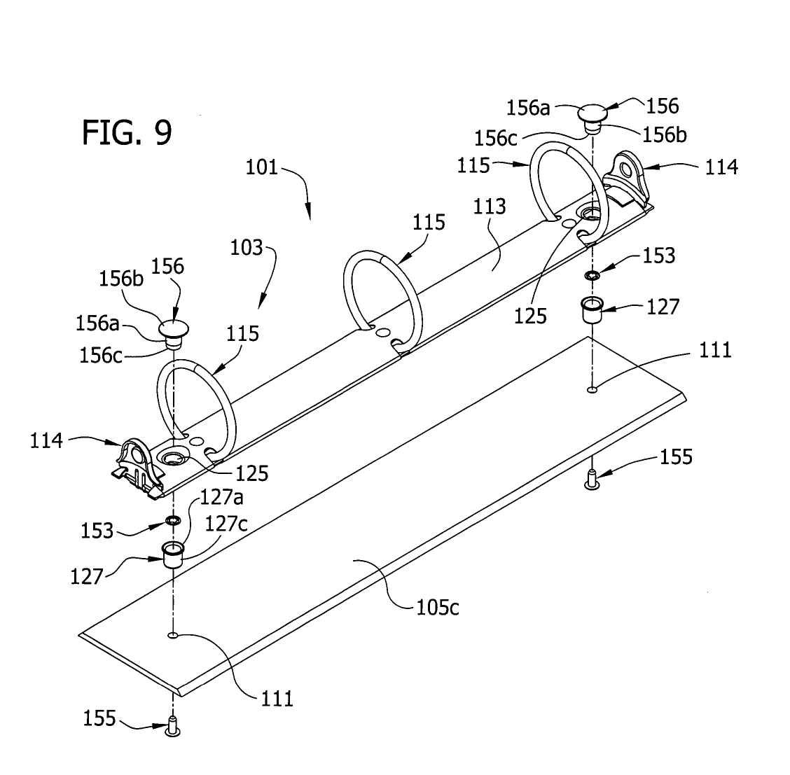

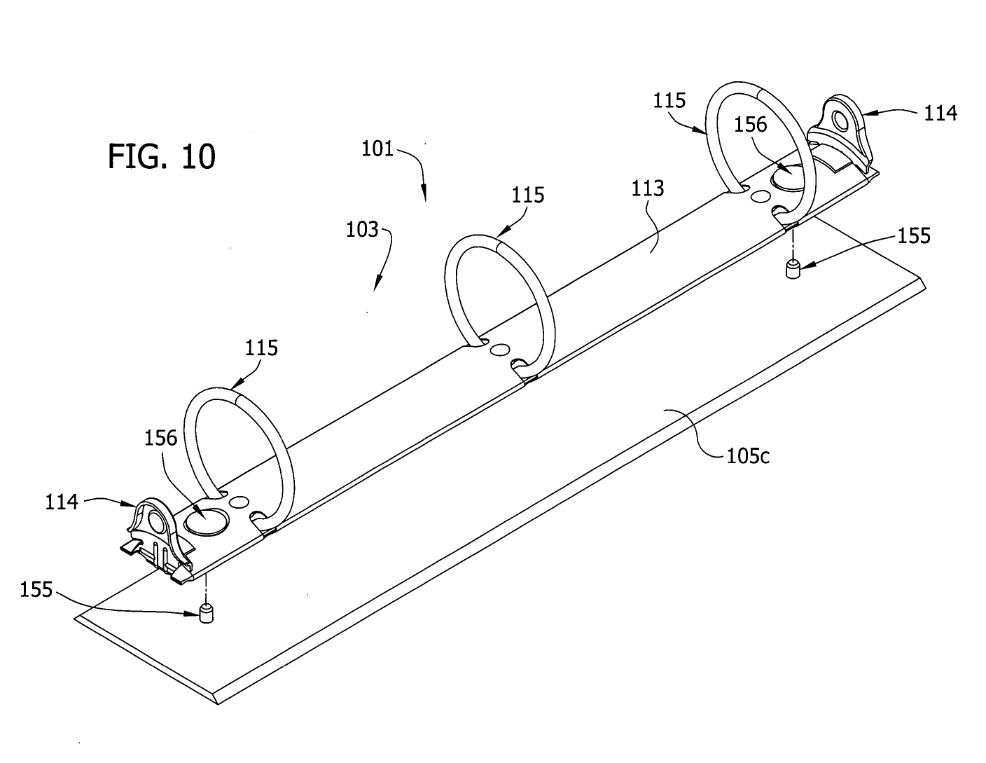

A fastening system adapted to attach a ring binder mechanism 103 to a cover 105 is shown in FIGS. 9-12 having another configuration. The ring binder mechanism 103 and cover 105 are substantially the same as the previously described ring binder mechanism 3 and cover 5 and therefore will not be described again. Corresponding parts are indicated by the same reference numbers used for the ring binder shown in FIGS. 1-8B plus “100.”

The fastening system in this configuration comprises two barrel bushings 127, two retainers 153, two fasteners 155, and two plugs 156. The fastening system components (i.e., barrel bushings, retainers, fasteners, and plugs) are indicated generally by their respective reference numbers. It is understood that more or fewer fastening system components could be used to secure the ring binder mechanism 103 of the cover 105. Each barrel bushing 127 includes a tubular wall 127c having open ends. The tubular wall defines an interior chamber of the barrel bushing 127. At a first end, each of the barrel bushings 127 includes a deformable lip 127a for attaching the bushing to the ring binder mechanism at one of two circular openings 125 in the upper surface of the housing 103. At a second end, each of the barrel bushings 127 includes a circular rim 127b that is folded inward of the bushing for supporting the bushing on the spine 105c. The retainers 153 and fasteners 155 in this configuration are substantially the same as the retainers 53 and fasteners 55 described and shown in the previous configuration of FIGS. 1-8. Accordingly, the retainers 153 and fasteners 155 will not be described in detail.

Each of the plugs 156 include a stem 156a having an outer surface and two ends. A head 156b is affixed to the stem 156a at one of its ends and is sized and shaped for capping one of the opening 125 in the housing 113 of the ring binder mechanism 103. An end 156c of the stem 156a opposite the head 156b has a circular recess 156d that is disposed in the approximate center of the end. The recess 156d is sized and shaped to receive one of the fasteners 155 therein. The outer surface of the stem 156a tapers as it approaches the end 156c to facilitate aligning and inserting the plug 156 into the interior chamber of the barrel bushing 127.

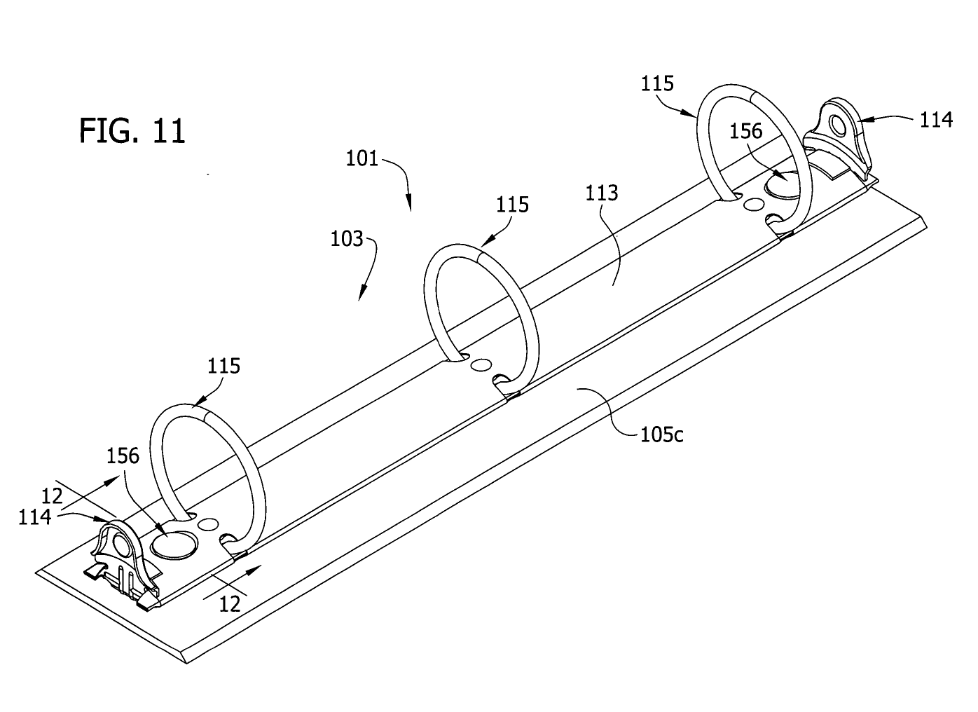

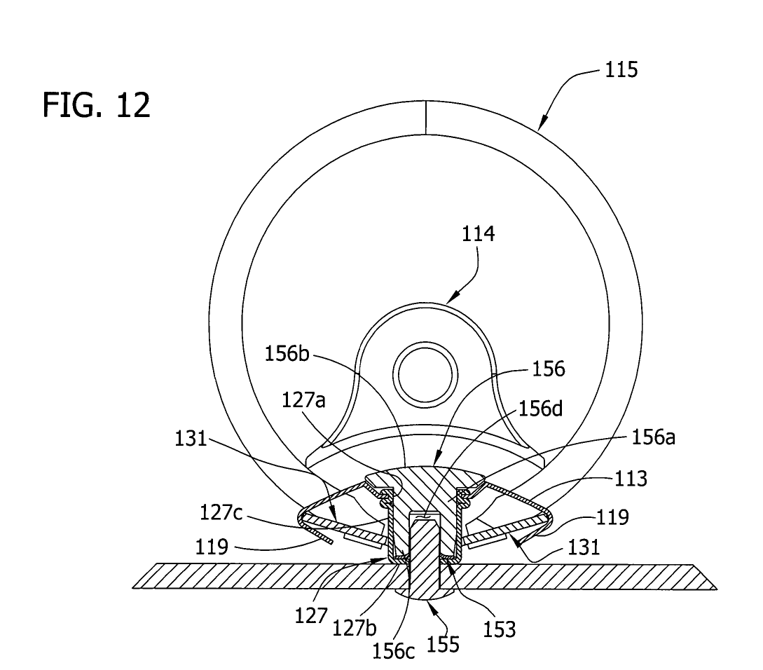

In use, each of the retainers 153 are placed in a respective barrel bushing 127 and the respective plugs 156 are aligned with and inserted into one of the barrel bushing. As a result, each of the retainers 153 is secured in the barrel bushing 127 by being sandwiched between the free end 156c of the plug 156 and the rim 127b of the barrel bushing. (FIG. 12). Each of the fasteners 155 is passed through one of the apertures 111 in the spine 105c of the cover 105, the opening 159 in a respective retainer 153, and into the recess 156d in the plug 156 for securing the ring binder mechanism 103 to the cover 105. FIGS. 11 and 12 illustrate the ring binder mechanism 103 secured to the spine 105c of the cover 105.

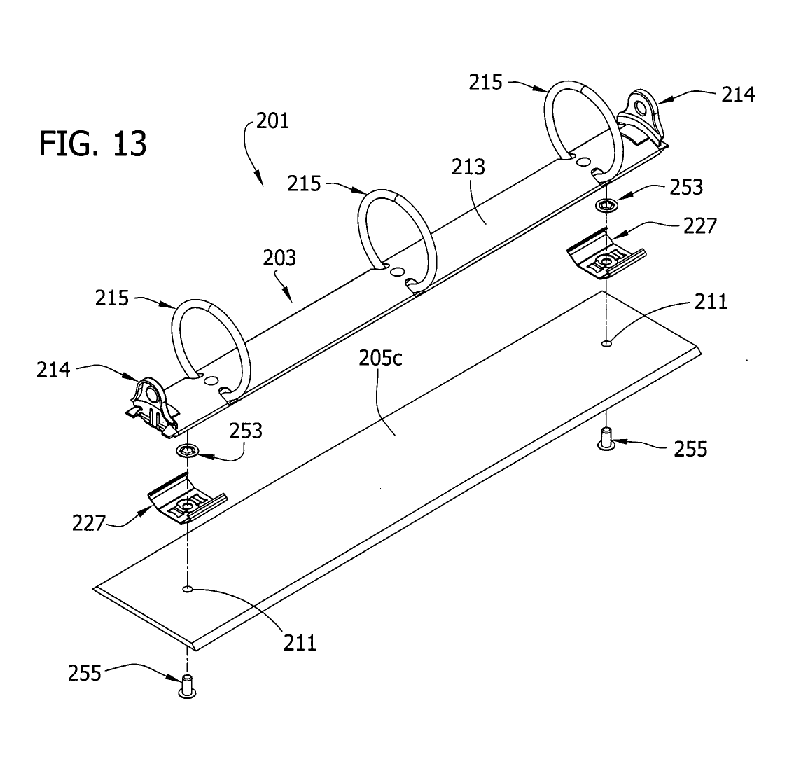

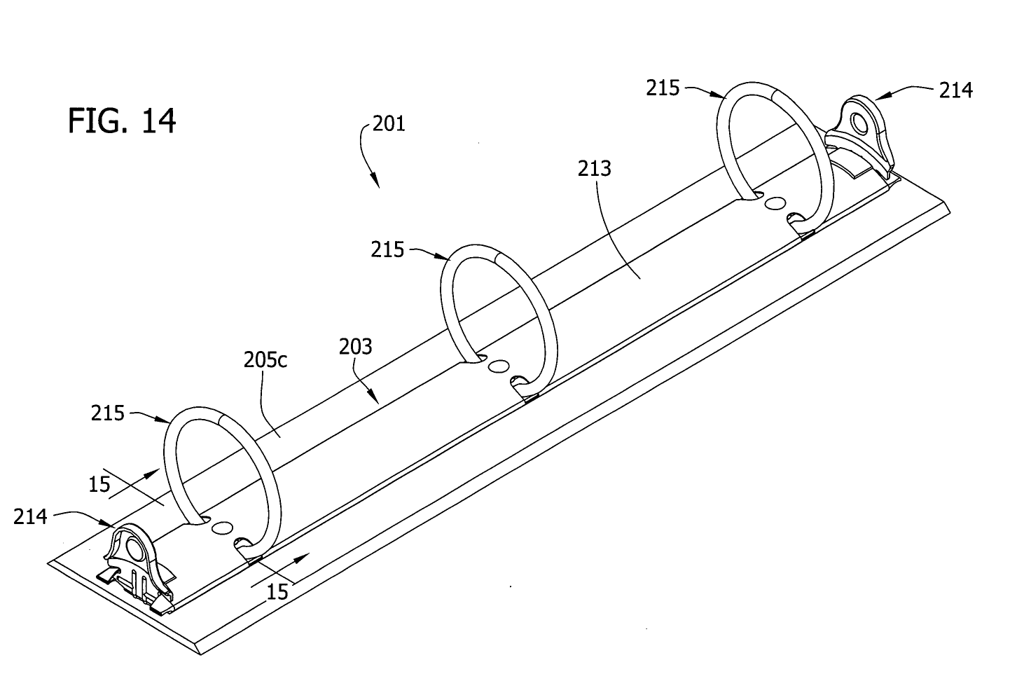

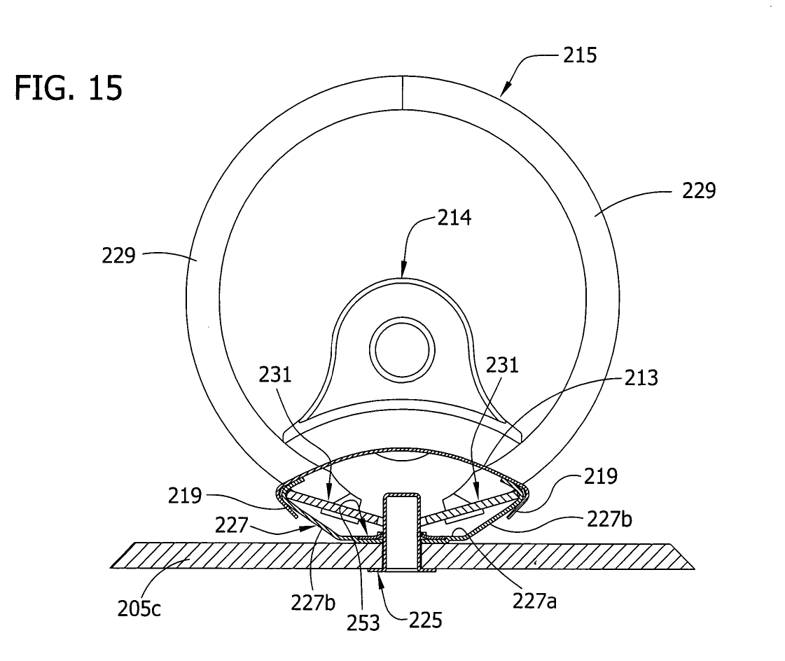

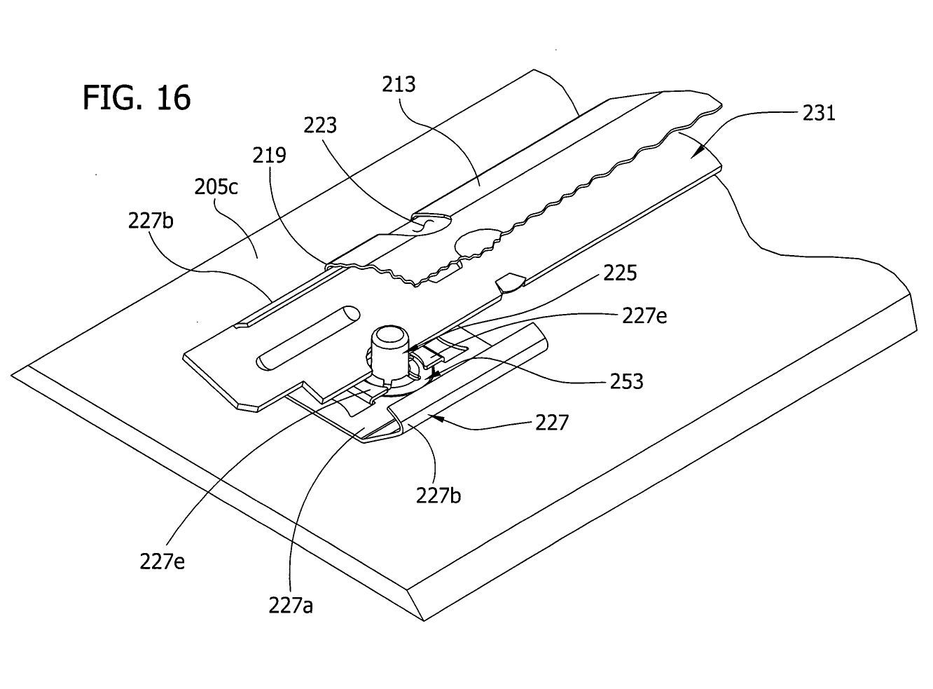

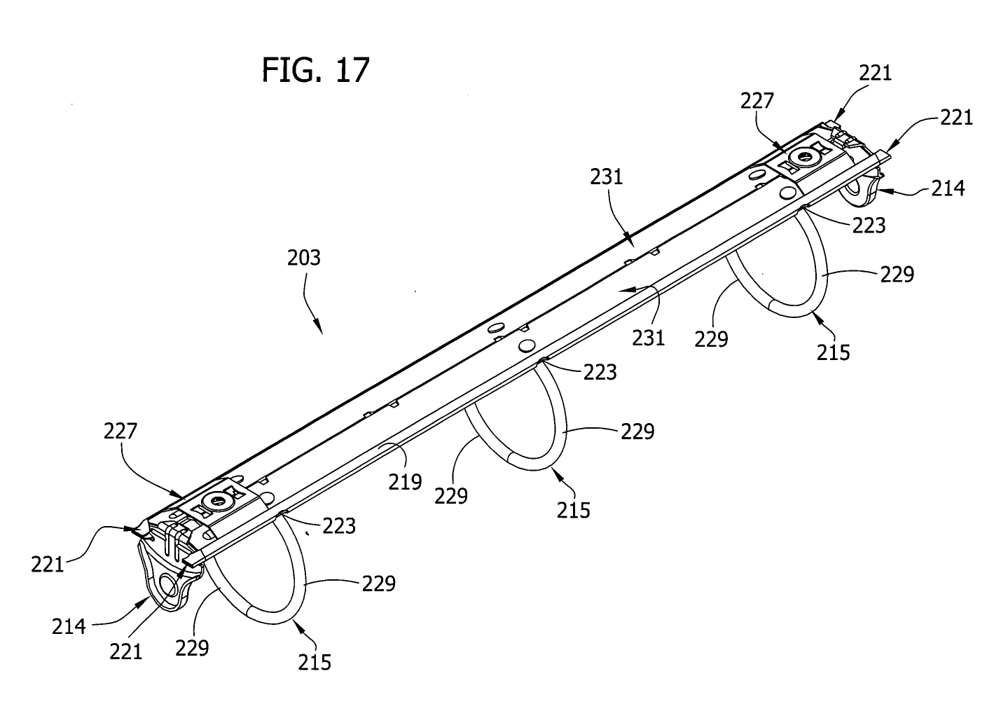

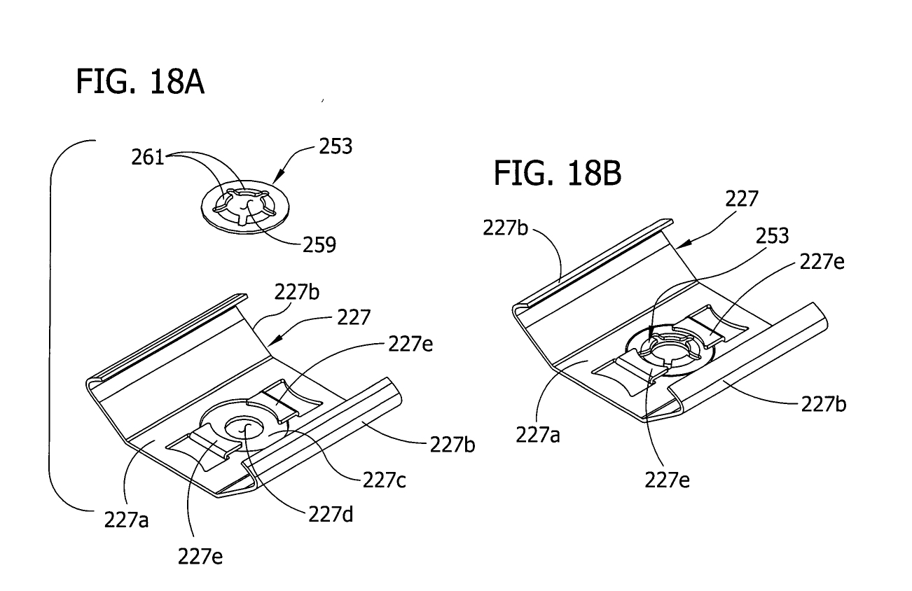

FIGS. 13-18B show yet another configuration of a fastening system for attaching a ring binder mechanism 203 to a cover 205 that is similar to the one shown in FIGS. 1-8B except that two clips 227, which attach to a housing 213 of the ring binder mechanism, are used to support two retainers 253 instead of the mounting posts 27 used in the configuration illustrated in FIGS. 1-8B. Since the clips 227 are the same only one will be described in detail. Referring to FIGS. 18A and 18B, the clip 227 includes a generally flat, rectangular base 227a (broadly, “a first end”) and a pair of side walls 227b (broadly, “a second end”) extending upwardly from longitudinal edges of the base. The base 227a of the clip 227 includes a circular seat 227c that is sized and shaped for receiving a retainer 253. The seat 227c has an opening 227d in the center thereof for aligning with an aperture 259 in a respective retainer 253 when the retainer is received on the seat. As a result, the fastener 255 extends through the opening 227d in the clip 227 and the aperture 259 in the retainer 253 when the fastener is used to secure the housing 213 to the spine 205c. A pair of bent tabs 227e, which are punched from the base 227a, extend above the seat 227c and are used to secure the retainer 253 in the seat.

Each of the side walls 227b of the clip 227 is roughly C-shaped in cross-section to match the shape of the sides of the ring binder mechanism housing 213. In this configuration, portions of each of the side walls 227b of the clip 227 are disposed in a spaced defined by one of the lips 219 between the ring binder mechanism housing 213 and a pair of hinge plates, indicated generally at 231. In this way, the clip 227 is secured to the housing 213. The clip 227 spaces the housing 213 from the spine 205c of the cover 205 so that the hinge plates 231 can move to open and close the rings 215. It is understood that the clip 227 can be attached to the housing 213 in other ways.

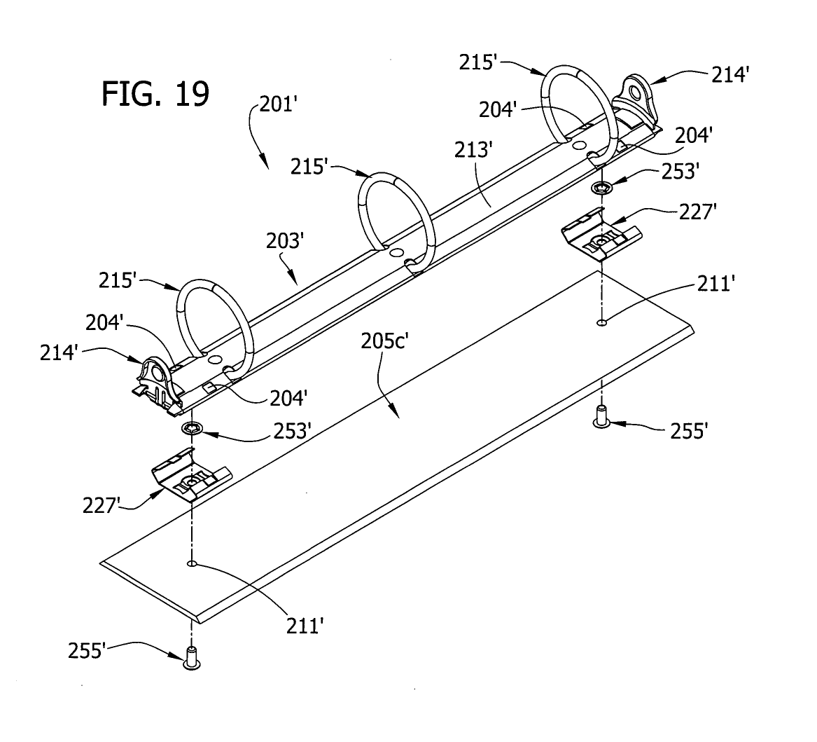

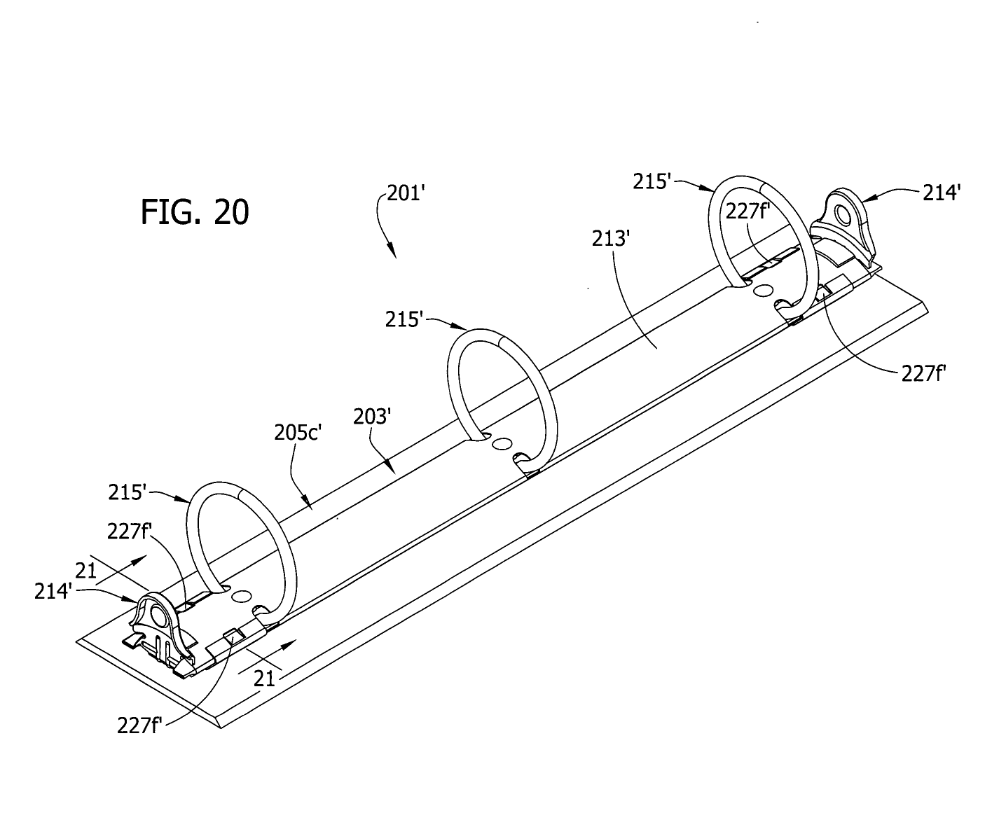

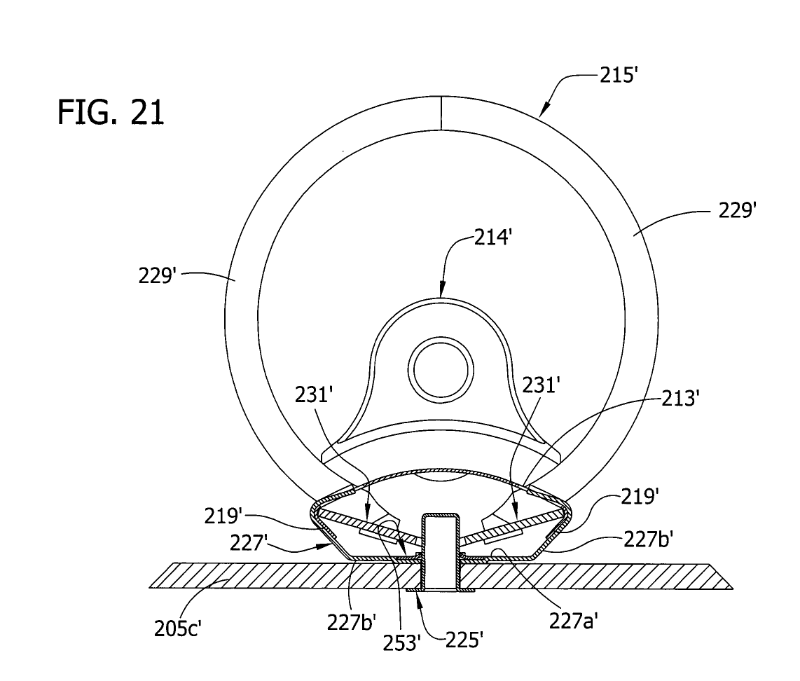

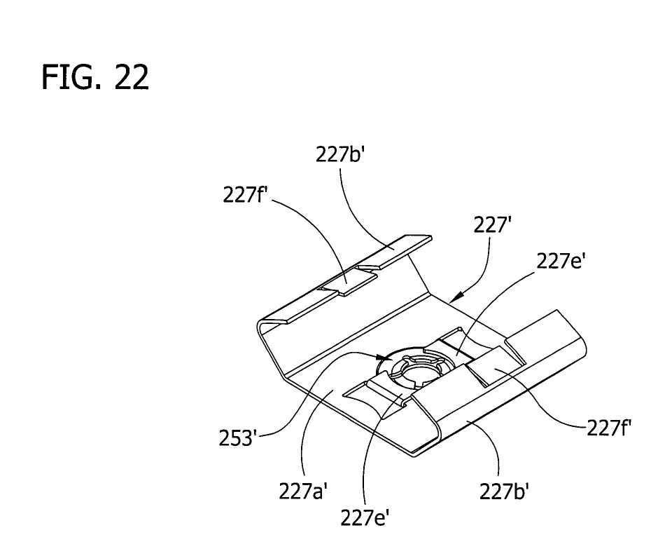

FIGS. 19-22 shown another configuration of a clip 227′ wherein the clip is secured to the exterior of a housing 213′ of the ring binder mechanism 203′. In this configuration, the spacing between opposed sidewalls 227b′ of the clip 227′ is slightly smaller than the width of the ring binder mechanism 203′. As the clip 227′ is slid or snapped onto the housing 213′ of the ring binder mechanism 203′, the sidewalls 227b′ flex outwardly away from a longitudinal axis of the ring binder mechanism. The resiliency of the sidewalls 227b′ cause the sidewalls to tightly grip the sides of the housing 213′ to attach the clip 227′ to the housing. The sidewalls 227b′ of the illustrated configuration further include locking tabs 227f′ that are received in openings 204′ in the housing 213′ to further secure the clip 227′ to the housing. The retainer 253′ and its cooperation with the fastener 255′ are the same as described for the version shown in FIGS. 13-18B.

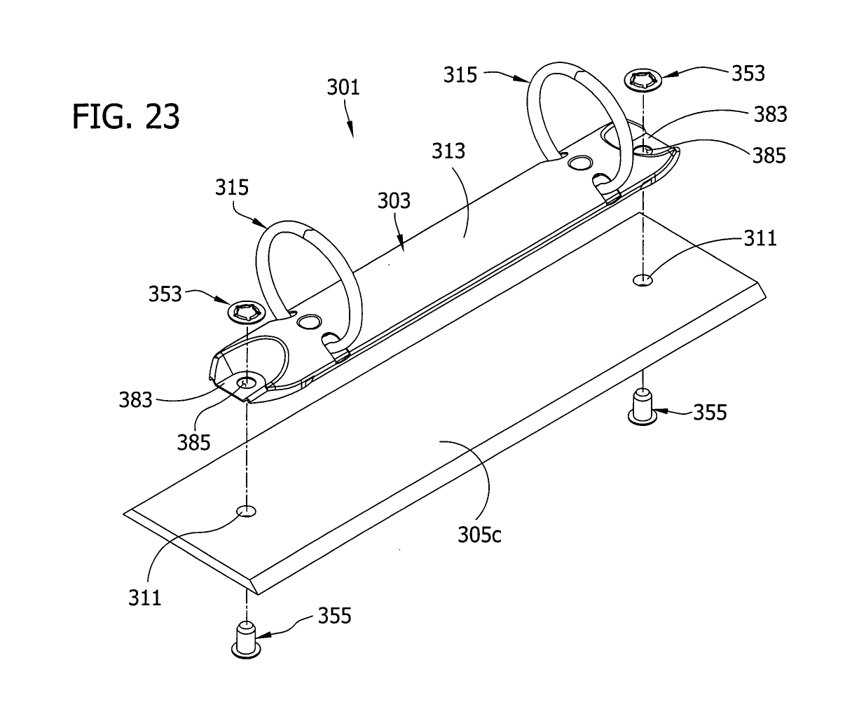

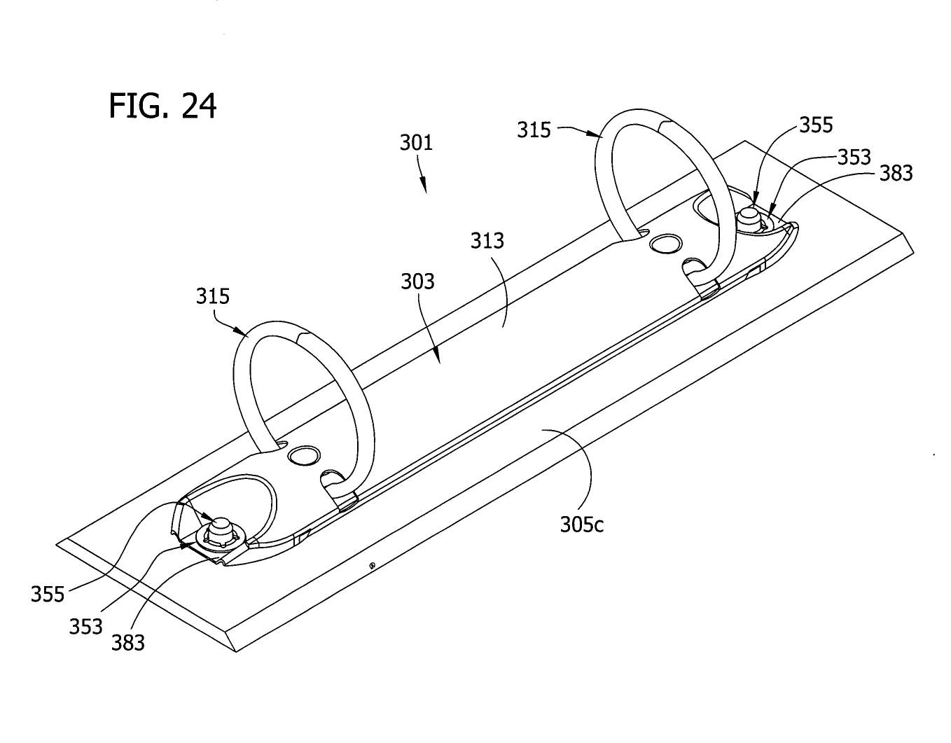

FIGS. 23 and 24 show yet still another configuration of the ring binder 301 of the present invention having a ring binder mechanism 303 and a cover 305. Since the cover 305 is substantially the same as the cover 5 of FIGS. 1-8, only a spine 305c of the cover is shown. In this configuration, the ring binder mechanism 303 includes an elongate housing 313 that supports two rings (each designated generally by reference numeral 315). Each of the rings 315 in this configuration include two ring members 329 that can be manually opened by pulling the ring members apart and closed by pushing the ring members together. The ring members 329 are pivotally mounted to hinge plates (not shown) that are substantially similar to the hinge plates 31 shown and described above with respect to FIGS. 1-8B.

The housing 313 is symmetrical with a roughly arch-shaped cross section and includes two transversely opposite longitudinally extending edges, and two longitudinal ends. The housing 313 includes two generally oblong recesses 383; one recess adjacent each of its longitudinal ends. The housing 313 is formed by way of the recesses 383 to engage the spine 305c to provide the necessary spacing for movement of the hinge plates. Each of the recesses 383 has an aperture 385 therein that is sized and shaped for aligning with apertures 311 in the spine 305c of the cover 305. The ring binder mechanism 303 is secured to the spine 305c by aligning a retainer 353 with each of the apertures 385 in the recesses 383 in the housing 313. Next fasteners 355 are slid through each of the apertures 311 in the spine 305c, the apertures 385 in the housing 313 and respective openings 359 in the retainers 353. With the fasteners 355 engaged with the retainers 353, as shown in FIG. 24, the ring binder mechanism 303 is secured to the spine 305c of cover 305. The retainers 353 and fasteners 355 in this configuration are substantially the same as the retainers 53 and fasteners 55 shown in FIGS. 1-8B and therefore will not be described again. Corresponding parts are indicated by the same reference numbers used for the ring binder shown in FIGS. 1-8B plus “300.”

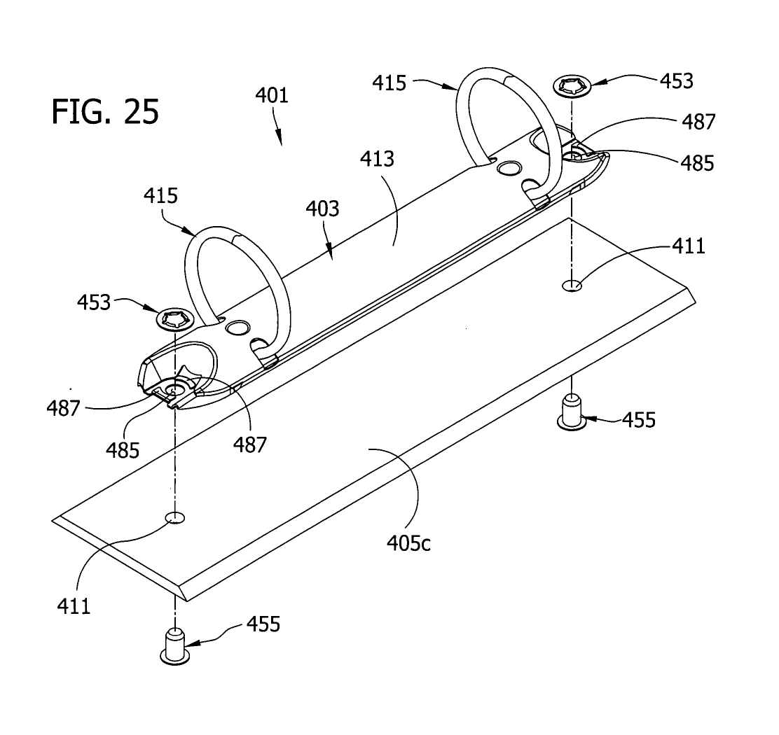

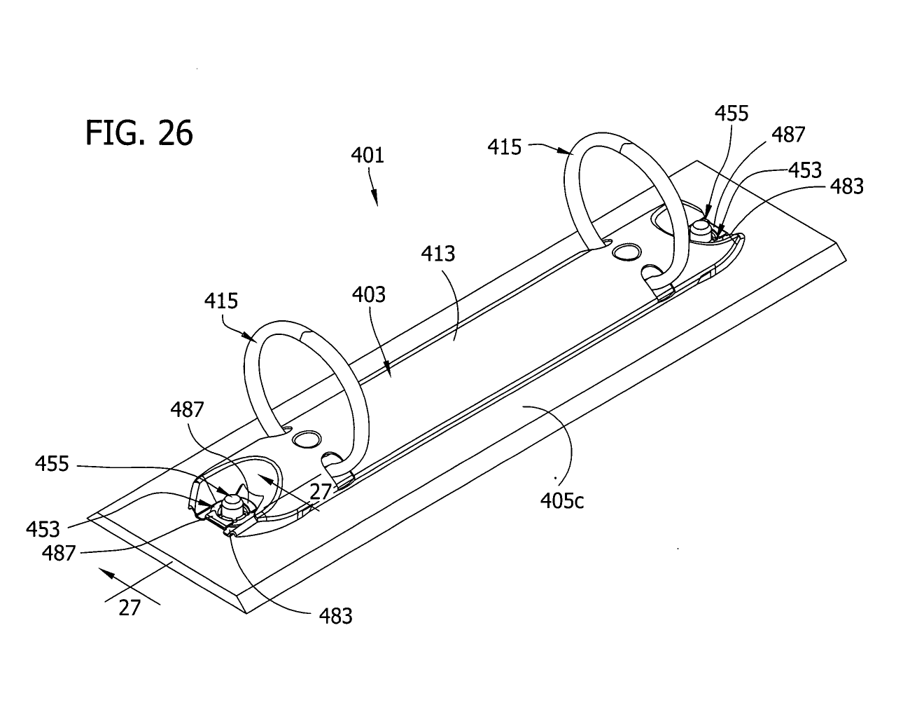

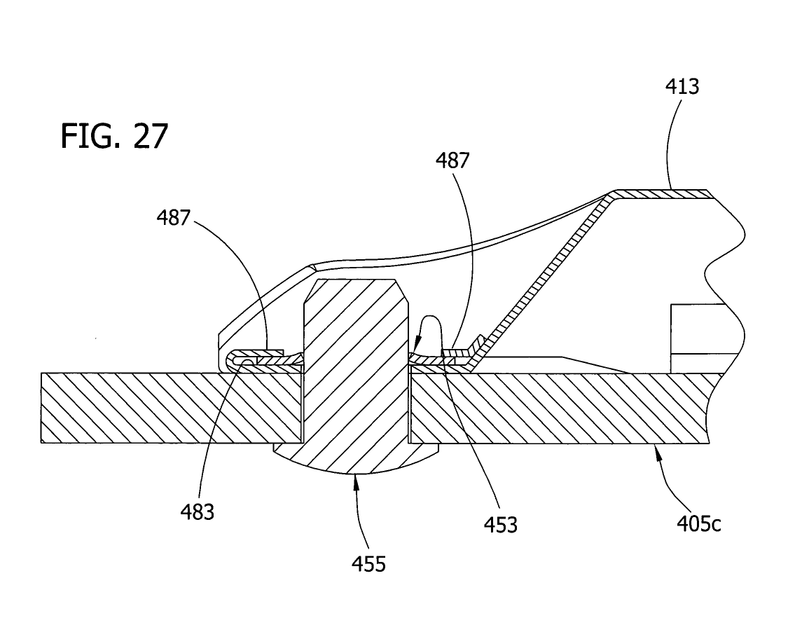

FIGS. 25-27 illustrate that the housing 313 of FIGS. 23 and 24 can be modified so that the retainers 453 can be mounted to the housing. In this housing configuration, portions of a housing 413 adjacent the recesses 483 in the housing were punched (or otherwise cut) and bent over to form bent tabs 487. The bent tabs 487 sandwich and thereby secure the retainer 453 between the tabs and a part of the housing 413 adjacent the apertures 485 in the recesses 483 in the housings. It is understood that other methods of mounting or attaching retainers 453 to the housing 413 could be used without departing from the scope of this invention.

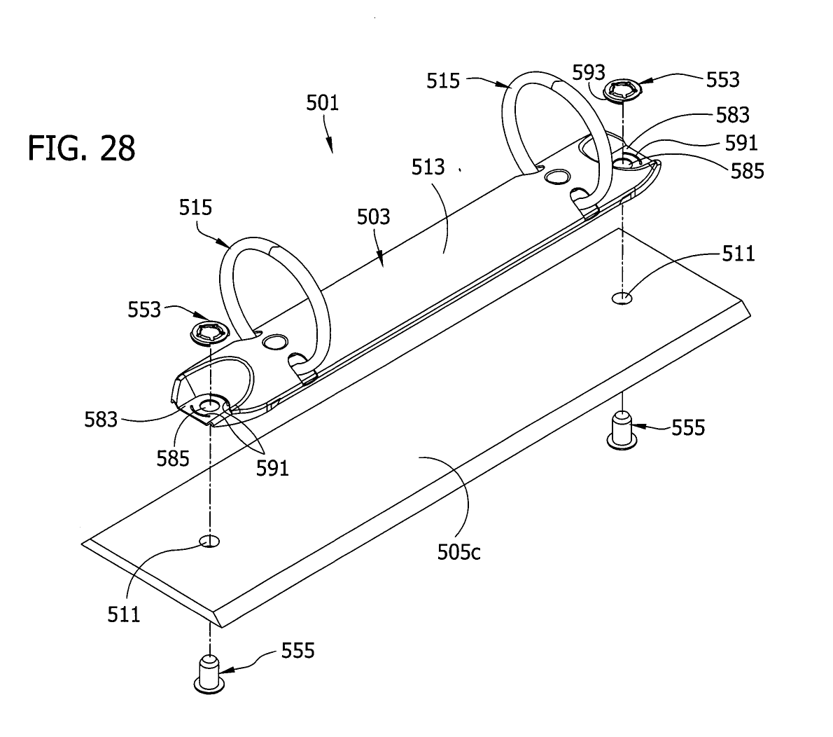

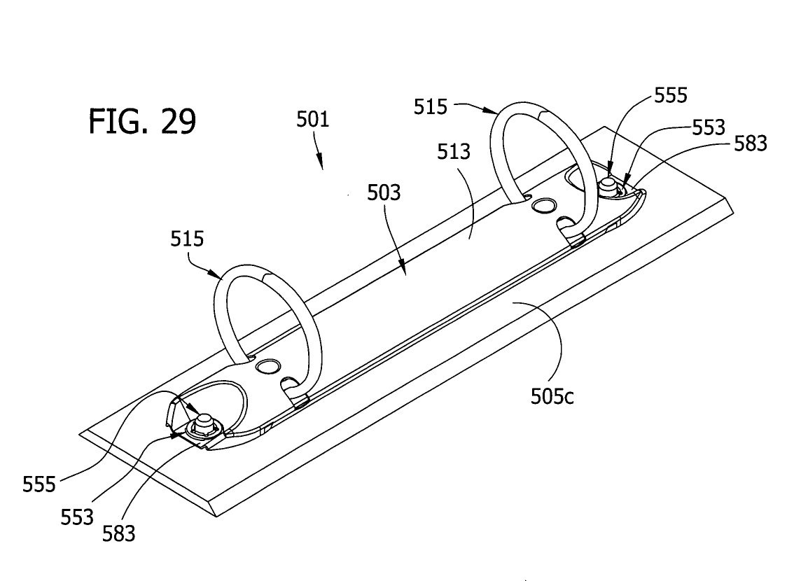

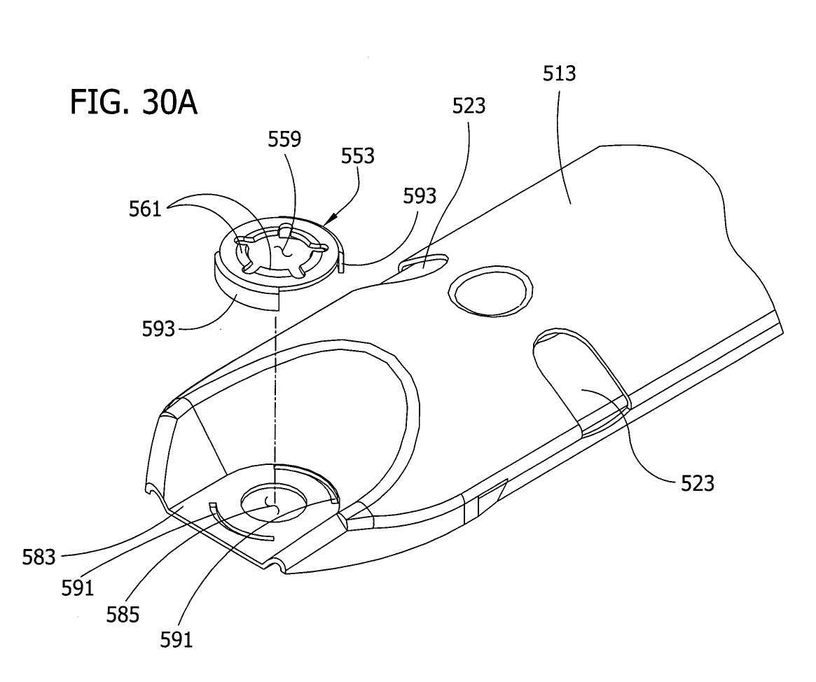

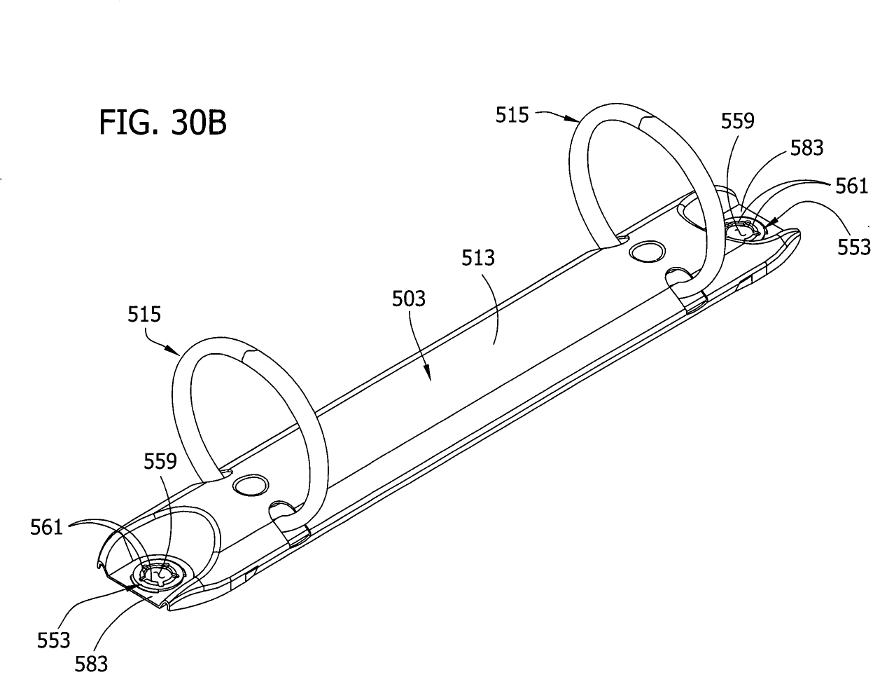

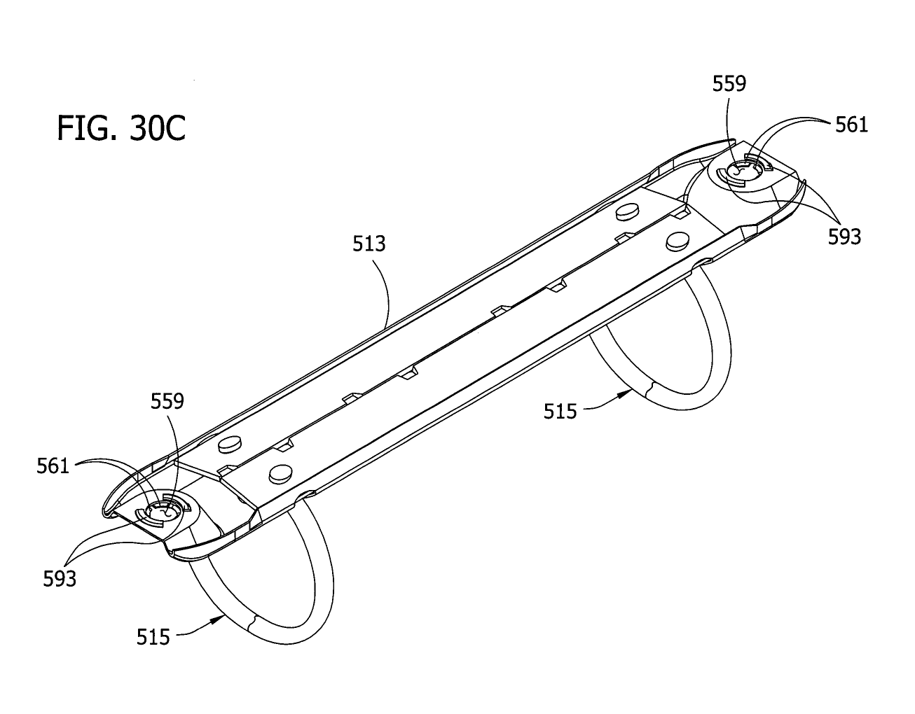

FIGS. 28-30C illustrate another modified version of the housing 313 of FIGS. 23 and 24 wherein retainers 553 are mounted to the housing. In this housing configuration, portions of the housing 513 adjacent the apertures 585 in the recesses 583 have been cut away to form arcuate openings 591. The retainers 553 include shoulders 593 for inserting into the arcuate openings 591 in the housing 513 (FIG. 30A). The shoulders 593 in the retainers 553 are bent over to thereby secure the shoulder to the housing 313 (FIGS. 30B and 30C). The shoulders 593 in the illustrated configuration are shown bent toward the aperture 585 in the housing 513 but it is understood that the shoulders could be bent away from the apertures.

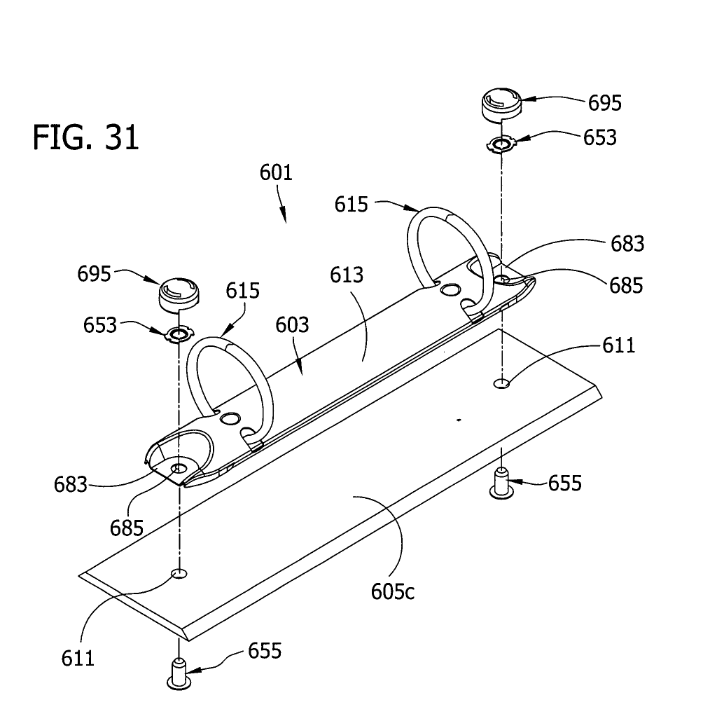

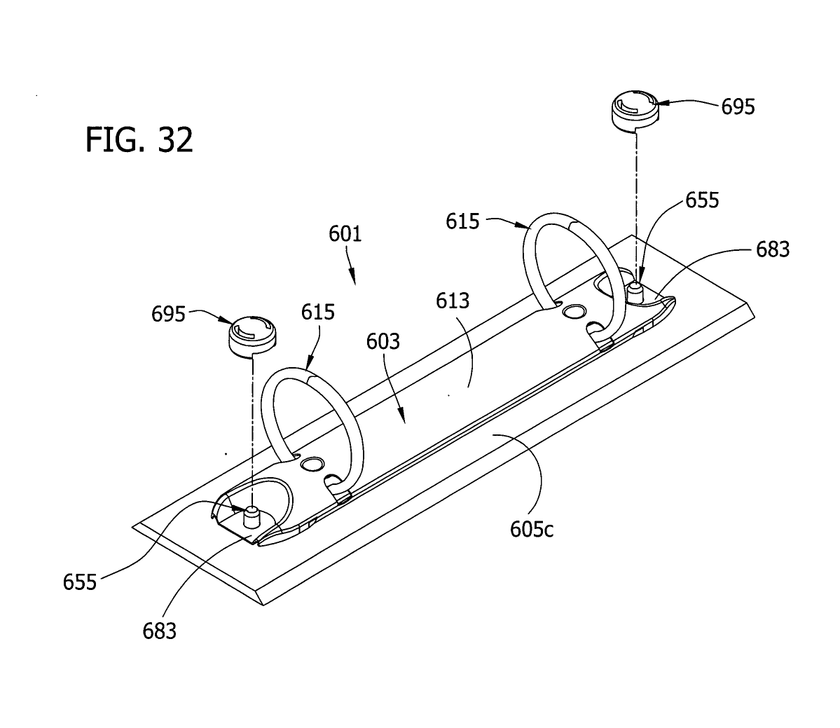

FIGS. 31-33C show a configuration similar to FIGS. 23 and 24 wherein each of the retainers 653 is received in a cap 695. In the configuration shown in FIGS. 31-33C, the retainer 653 can be rotatably secured in the cap 695. The cap includes a recess 695d, two arcuate ribs 695a adjacent the recess, and two channels 695b formed in the ribs 695a. The retainer 653 of this configuration has four tabs 661 defining an opening 659 in the retainer. The retainer 653 also includes a pair of ears 660 that are adapted to slide into the two channels 695b formed in the ribs 695a of the cap 659. To secure the retainer 653 to the cap 659, the retainers are placed on the cap so that the ears 660 of the retainer are positioned between the ribs 695a of the cap (FIG. 33A). The retainer 653 is then rotated to move the ears 660 into the channels 695b.

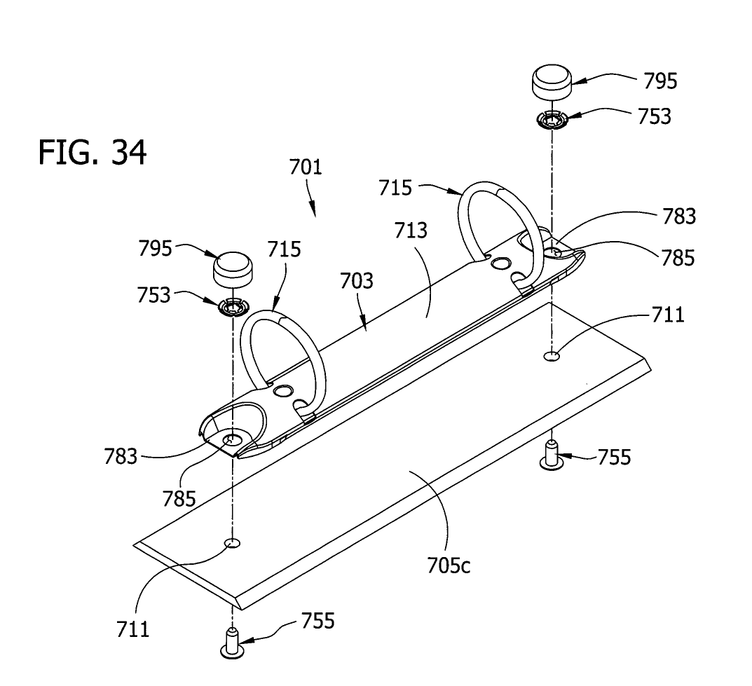

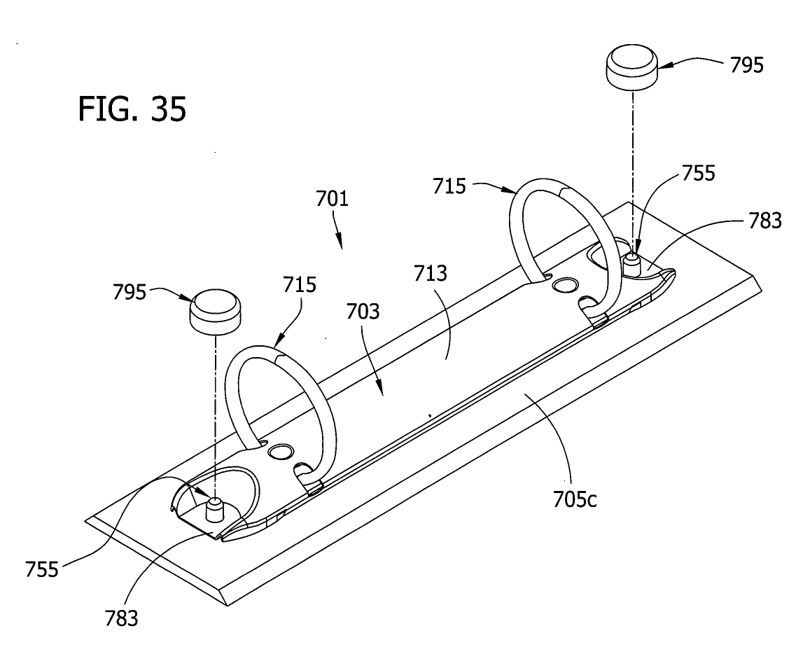

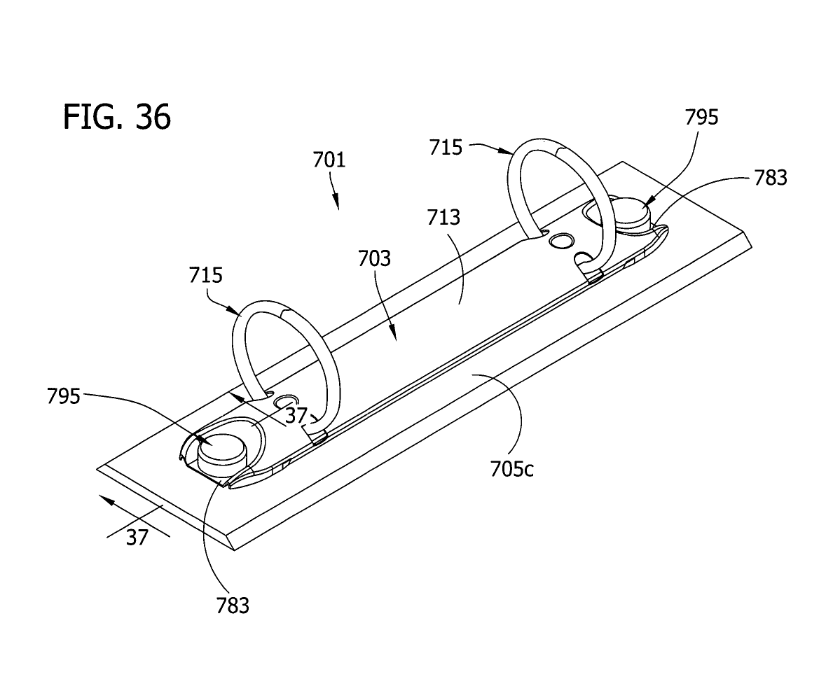

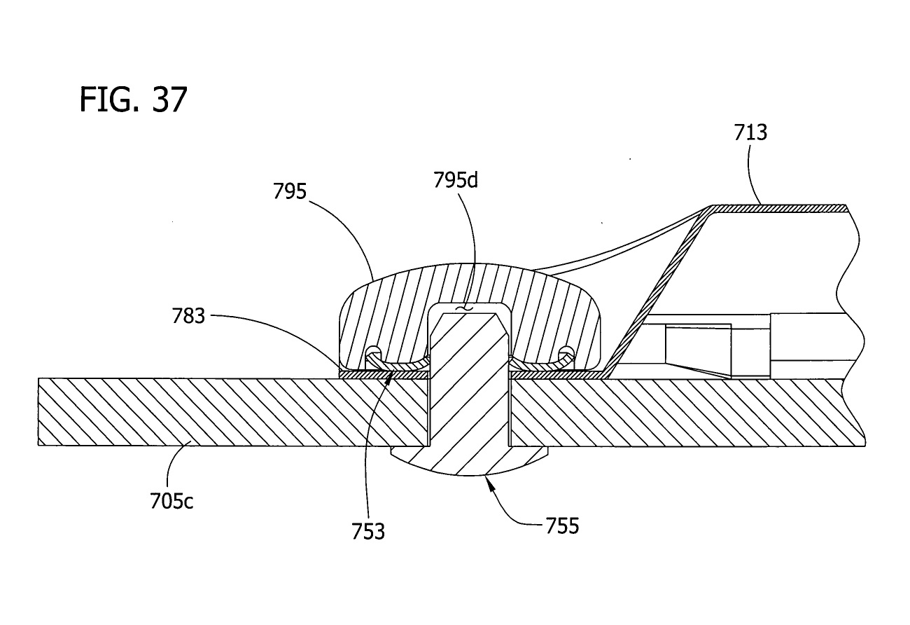

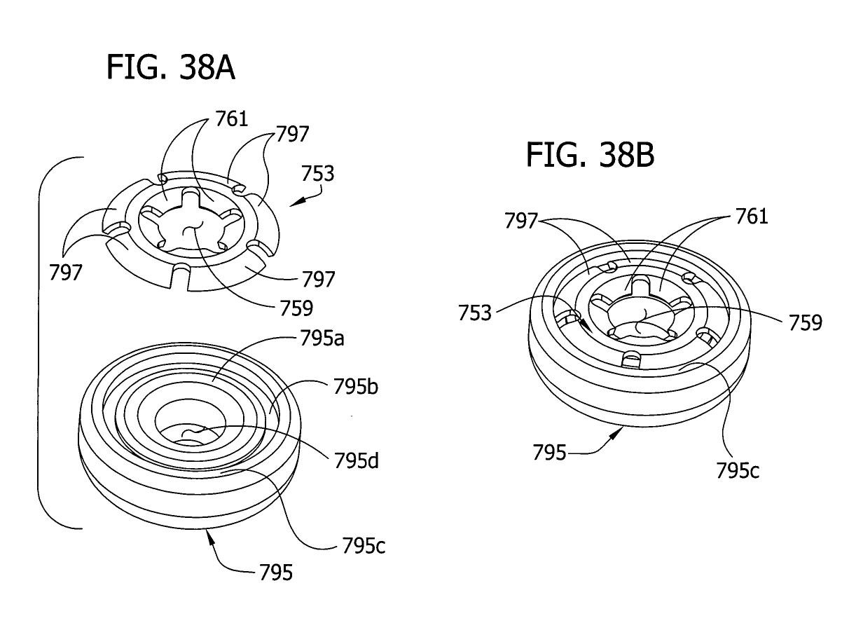

A retainer 753 having a snap connection with a cap 795 is shown in FIGS. 34-38B. In this configuration, the retainer 753 includes five ears 797 and five tabs 761 defining an opening 759 (see, FIGS. 38A and 38B). The cap 795 includes a recess 795d, a first annular rib 795a adjacent the recess 795d, and a second annular rib 795c spaced from the first annular rib. The first and second annular ribs 795a, 795c cooperate to define a channel 795b. To secure the retainer 753 to the cap 795, the retainer is aligned with and pressed against the cap. The pressing force causes the ears 797 of the retainer 753 to snap into the channel 795b of the cap 795 to the thereby affix the retainer to the cap. It is understood that the retainer can be affixed to the cap in other ways. It is also understood that the retainer and cap could be formed as independent pieces that attach to the fasteners separately. The fastener 755 secures the housing 713 to the spine 705c by being pressed into the cap 795 so that the retainer 753 grips the fastener as in the prior versions.

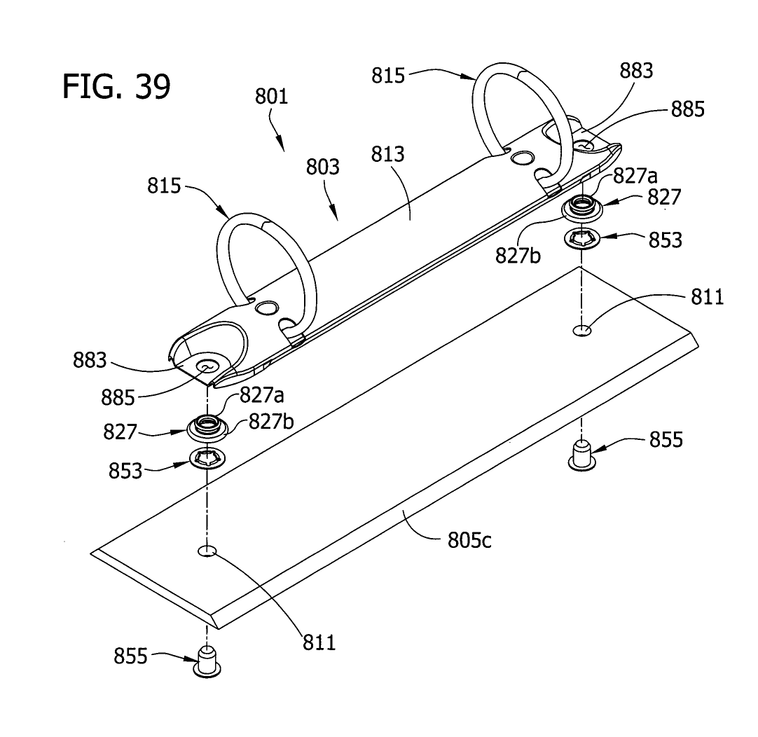

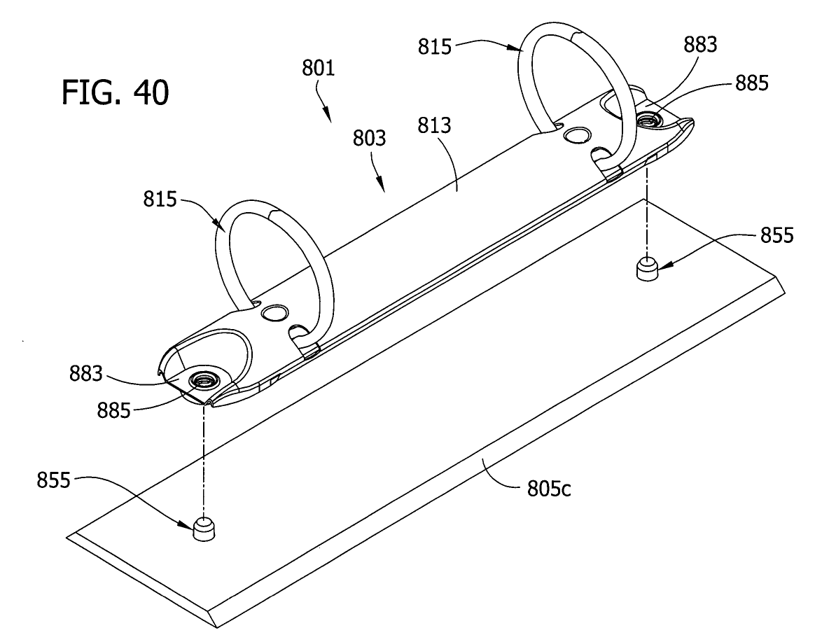

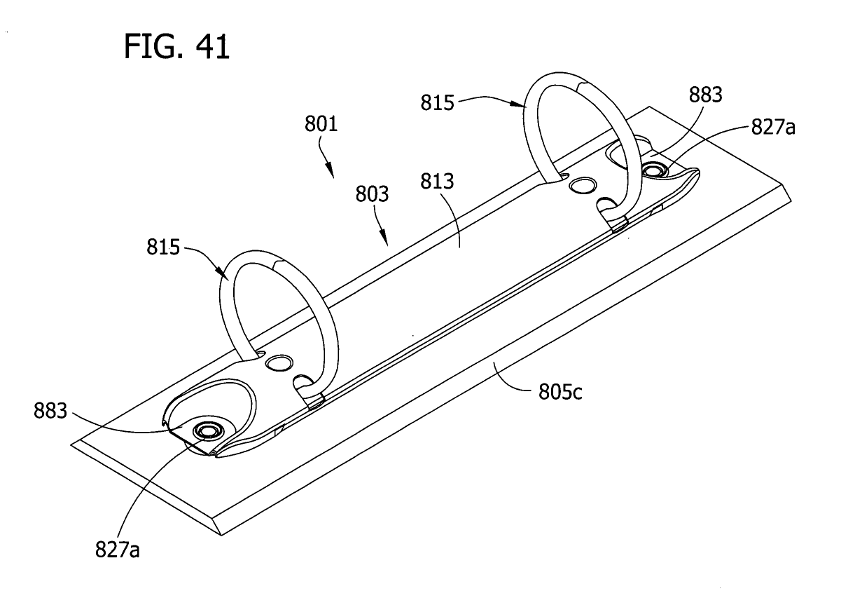

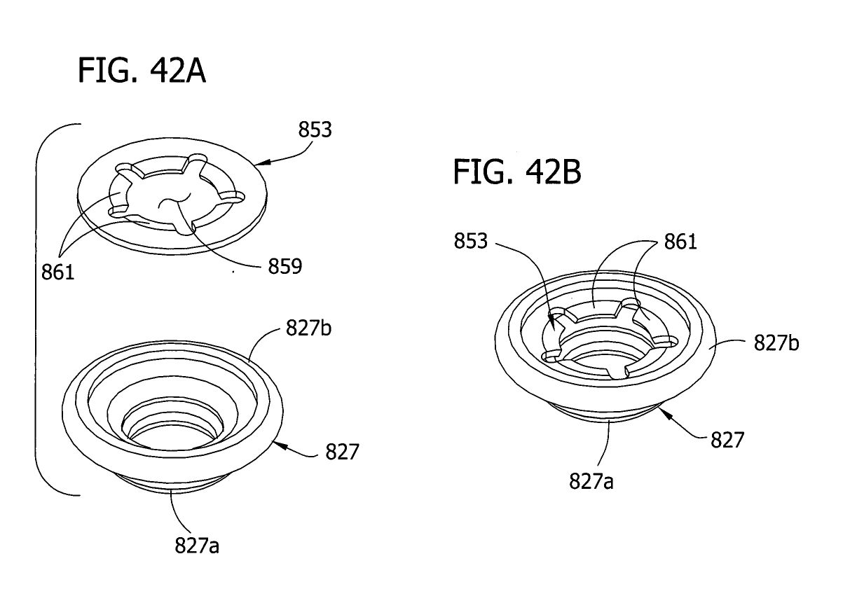

FIGS. 39-42B show a further configuration of the fastening system of the present invention. In this configuration, short mounting posts 827 are used to secure retainers 853 to a housing 813 of a ring binder mechanism 803 for attaching the ring binder mechanism to a spine 805c of a cover 805. The cover of FIGS. 39-42B is substantially the same as the cover 5 of FIGS. 1-8, and the ring binder mechanism 803 of FIGS. 39-42B is substantially the same as the ring binder mechanism 303 of 23 and 24. Each mounting post 827 is tubular in shape and has two open ends. At a first end, each of the mounting posts 827 includes a deformable lip 827a that attaches the mounting post to one of two circular openings 885 in the upper surface of the housing 813 (FIG. 41). At a second end, each of the mounting posts 827 includes a circular rim 827b defining an aperture 857 in the second end. Each of the retainers 853 are received in the aperture 857 of the mounting posts 827 and held in place under the circular rim 827b (FIGS. 42A and 42B) by a bent over outer edge of the circular rim. Each of the retainers 853 is sized and shaped for receiving and retaining one of two fasteners 855 for attaching the ring binder mechanism 803 to the spine 805c of the cover 805. The retainer 853 and fastener 855 are substantially the same as the retainer 53 and fastener 55 shown in FIGS. 1-8B.

Components of the mechanism of the present invention are made of a suitable material, such as metal (e.g., steel). But mechanisms made of a non-metallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

1. A ring binder mechanism comprising:
an elongate housing;
at least one ring for mounting loose leaf paper, the ring including first and second ring members, each of the ring members being supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring;
at least one mounting structure extending outwardly from the housing and having first and second ends, the first end being adapted for attachment to the housing and the second end having an aperture therein;
a retainer formed separately from and secured to the mounting structure, and
a fastener adapted for connection with the retainer for securing the housing to a substrate.

2. The ring binder mechanism as set forth in claim 1 wherein the retainer includes an opening and a plurality of tabs extending into the opening.

3. The ring binder mechanism as set forth in claim 2 wherein the tabs are angled in the direction of insertion of the fastener into the retainer.

4. The ring binder mechanism as set forth in claim 1 wherein the mounting structure is formed to receive the retainer therein.

5. The ring binder mechanism as set forth in claim 4 wherein the mounting structure is deformed to capture the retainer therein.

6. The ring binder mechanism as set forth in claim 4 wherein the mounting structure is a mounting post.

7. The ring binder mechanism as set forth in claim 4 wherein the mounting structure is a barrel bushing.

8. The ring binder mechanism as set forth in claim 7 further comprising a plug adapted for insertion in the barrel bushing through an aperture in the first end of the barrel bushing.

9. The ring binder mechanism as set forth in claim 4 wherein the mounting structure is a clip.

10. The ring binder mechanism as set forth in claim 9 wherein the clip includes a seat for receiving the retainer and tabs adjacent the seat for holding the clip in the seat.

11. The ring binder mechanism as set forth in claim 1 wherein the fastener comprises a shaft and a head attached to an end the shaft.

12. The ring binder mechanism as set forth in claim 1 wherein the retainer is affixed to the mounting structure adjacent the aperture in the second end of the mounting structure.

13. The ring binder mechanism as set forth in claim 1 in combination with a cover defining the substrate, the mounting structure, retainer and fastener mounting the housing on the cover.

14. The combination as set forth in claim 13 wherein the cover comprises a front panel, a back panel, and a spine, the front and back panels being hingedly attached to the spine so that the panels are movable to selectively cover or expose loose leaf pages capable of being retained by the ring binder mechanism, the cover receiving the fastener for attaching the ring binder mechanism to the cover.

15. The combination as set forth in claim 14 wherein the cover includes at least one aperture for allowing a portion of the fastener to pass the aperture to the retainer.

16. A ring binder mechanism comprising:
an elongate housing, the housing having a top and at least one opening extending through the housing;
at least one ring for mounting loose leaf paper, the ring including first and second ring members, each of the ring members being supported by the housing for movement relative to each other between a closed position in which the ring members form a substantially continuous, closed loop for allowing loose-leaf paper retained by the ring to be moved along the ring from one ring member to the other, and an open position wherein the ring members of the ring form a discontinuous, open loop for adding or removing loose-leaf paper from the ring;
at least one fastener having a stem and a head; and
at least one retainer associated with the housing for connection with the fastener for securing the housing to a substrate, the fastener being sized and shaped so that when the fastener is used to secure the housing to a substrate, a portion of the stem of the fastener extends above at least a portion of the top of the housing.

17. The ring binder mechanism as set forth in claim 16 wherein the housing includes at least one recess, the stem of the fastener extending above the recess in the housing.

18. The ring binder mechanism as set forth in claim 17 wherein the recess housing further comprises at least one tab for holding the retainer in relationship with the housing.

19. The ring binder mechanism as set forth in claim 16 further comprising a cap for capping the portion of the stem of the fastener that extends above the top of the housing.

20. The ring binder mechanism as set forth in claim 19 wherein the retainer is mounted on the cap.

21. The ring binder mechanism as set forth in claim 16 wherein the housing includes a cutout and the retainer includes a shoulder for insertion into the cutout to align the retainer with respect to the housing.

22. The ring binder mechanism as set forth in claim 16 wherein the ring binder mechanism includes two fasteners and two retainers for securing the ring binder mechanism to the substrate.
